(19) United States
(12) Patent Application Publication
(10) Pub. No.: US 2026/0156509 A1
(43) Pub. Date: Jun. 4, 2026

(54) METHOD FOR SIGNALING BETWEEN NETWORK AND USER EQUIPMENT FOR BEAM-CODEBOOK BASED BEAM PREDICTION

(71) Applicant: Google LLC, Mountain View, CA (US)

(72) Inventor: Yushu ZHANG, Beijing (CN)

(21) Appl. No.: 19/122,631

(22) PCT Filed: Nov. 4, 2022
(86) PCT No.: PCT/CN2022/130087

§ 371 Date: Apr. 18, 2025

(51) Int. Cl. H04W 24/10; H04B 7/0417

(52) U.S. Cl. CPC H04W 24/10; H04B 7/0417

(57) ABSTRACT

This disclosure provides systems, devices, apparatus, and methods, including computer programs encoded on storage media, for signaling beam codebook based beam prediction between a network entity and user equipment (UE) devices. For example, a UE device receives from a network entity a first control signaling including at least one beam codebook representing beam-related assumptions and a first set of parameters for a predicted beam report. The UE device measures quality of the downlink reference signals from the network entity based on the beam information in the first control signaling. The UE device generates a beam prediction using the at least one beam codebook, to predict quality of beams transmittable by the network entity, based on the measured quality of the downlink reference signals. The UE device transmits, to the network entity, the predicted beam report generated according to first set of parameters.

### FIELD

The present disclosure relates generally to wireless communication, and more particularly, to enhancing beam prediction.

### BACKGROUND

The Third Generation Partnership Project (3GPP) specifies a radio interface referred to as fifth generation (5G) new radio (NR) (5G NR). An architecture for a 5G NR wireless communication system can include a 5G core (5GC) network, a 5G radio access network (5G-RAN), a user equipment (UE), etc. The 5G NR architecture might provide increased data rates, decreased latency, and/or increased capacity compared to other types of wireless communication systems.

A cell radius/coverage area of a base station might be based on a link budget. The link budget refers to an accumulation of total gains and losses in a system, which provide a received signal level at a receiver, such as a UE. The receiver may compare the received signal level to a receiver sensitivity to determine whether a channel provides at least a minimum signal strength for signals communicated between the receiver and a transmitter (e.g., the UE and the base station). To increase the link budget, a network entity (e.g., gNodeB, or gNB) or a UE device may use analog beamforming. For example, a pair of gNB-UE may maintain multiple beams and select one based on signal strength or similar criteria. A good gNIB-UE beam pair can reduce the coupling loss so that the beam pair provides significant coverage gain. The gNB-UE may perform beam selection procedures per standard (e.g. 3GPP TS 38.214). For example, a UE device may measure downlink reference signals and report the measurements to a network entity. The network entity then indicates to the UE device a selected beam based on the reported measurements.

In some cases, the UE device performs layer 1 reference signal receiving power (L1-RSRP) measurements and reports to the network entity based on at least one downlink reference signal. In some cases, the UE device performs layer 1 signal-to-interference plus noise ratio (L1-SINR) measurements and reports to the network entity based on at least one downlink reference signal. The network entity may indicate to the UE device a selected beam via, e.g., transmission configuration indicator (TCI) indication and quasi-co-located (QCL) indication.

With the help of machine learning (ML), the UE device needs not measure all beams transmittable by the network entity (e.g., a grid of beams, or beam grid), to identify the best beam. For example, an ML model is trained to predict, based on measurements of only a subset of beams of a beam grid, the performance of multiple beams of the beam grid transmittable from the network entity. A trained ML model or an ML model to be trained relies on variable assumptions of beam grid configurations (e.g., spread, grid numbers, etc.). The beam grid assumptions on the UE device side might differ from the beam grid assumptions on the network entity side, causing beam prediction errors.

### SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

The present disclosure provides methods, systems, and techniques for signaling beam codebook based beam prediction between a network entity and user equipment (UE) devices.

A network-UE pair is able to communicate using multiple beams. Beam management includes a network entity transmitting reference signals and a UE device measuring the reference signals and transmitting feedback on the measured reference signals to the network entity. Based on the feedback (and machine learning (ML) predictions), the network entity selects which beam (among multiple available beams corresponding to different antenna panel configurations) to use. The selected beam is one of the beams expected to have highest quality. The beam quality is based, for example, on signal to noise ratio or signal energy among all the candidate beams. As the UE device moves relative to the network entity in varying environment conditions, however, the quality of the selected beam changes (e.g., a different beam may become better than the currently-selected one) and the beam selection process is reiterated. Correctly predicting a next best beam in the beam selection process (e.g., by ML beam predictions) with reduced or minimal downlink measurements may substantially improve the operation efficiency. The accuracy of the ML beam prediction is significantly affected by the accuracy of the beam-related assumptions.

In beam management utilizing ML beam prediction, a network selects, from the multiple beams, a beam that likely provides significant better quality than other possible beams. One of the factors influencing the selection is UE's measurement result of a subset of the multiple beams. Another factor in the beam selection a beam quality prediction performed using an ML model and based on the subset of beams measurement so that the beam may be selected without measuring all the beams. For accurate prediction results, the ML model has to be based on beam formation assumptions corresponding to the current situation. Antenna configurations and/or characteristics of beam grids (e.g., a spatial grid or a geometric representation of the multiple beams) form a beam codebook. Aspects of the present disclosure provide techniques and methods for signaling between the UE and the network, relative to the use of such beam codebooks thereby enabling the ML model to generate accurate beam predictions.

The ML model includes various parameters corresponding to a beam grid (e.g., the multiple beams formed by one or more antenna panels at the network entity). The beam grid assumptions, for example, may pertain to a number of beams in the horizontal and/or vertical directions, the angles of spread of the beams, and others. When the beam grid assumptions are faulty, the prediction results lose accuracy and are not reliable. Aspects of the present disclosure promotes beam selection being performed based on correct beam assumptions, via a dialogue between the network entity and the UE device regarding the beam codebook (e.g., describing the beam prediction assumptions) used for beam prediction.

For example, a UE device receives from a network entity a first control signaling. The first control signaling includes at least beam information of a first set of downlink reference signals corresponding to a subset of a grid of beams transmittable by the network entity. The first control signaling includes at least one beam codebook representing beam-related assumptions. The first control signaling also includes a first set of parameters for a predicted beam report to be generated by the UE device for the network entity. The UE device measures quality of the downlink reference signals from the network entity based on the beam information in the first control signaling. The UE device generates a beam prediction using the at least one beam codebook, to predict quality of beams transmittable by the network entity, based on the measured quality of the downlink reference signals. The UE device then transmits, to the network entity, the predicted beam report generated according to first set of parameters.

In some cases, the at least one beam codebook includes parameters for calculating antenna phase offsets. For example, the parameters include one or more of: a horizontal angle of span of a beam grid transmittable by the network entity via an antenna device; a vertical angle of span of the beam grid; a number of horizontal beams of the beam grid of the antenna; a number of vertical beams of the beam grid; a vertical and horizontal angle for each beam; a number of horizontal antenna ports; a number of vertical antenna ports; an antenna spacing in a vertical space domain; or an antenna spacing in a horizontal space domain.

In some cases, the at least one beam codebook includes parameters for calculating digital Fourier transform (DFT) vectors characterizing beams. For example, the parameters include one or more of an oversampling factor in the horizontal space domain; an oversampling factor in the vertical space domain; a number of horizontal antenna ports; and a number of vertical antenna ports.

### BRIEF DESCRIPTION OF THE DRAWINGS

FIG. 1 illustrates a diagram of a wireless communications system that includes a plurality of user equipments (UEs or UE devices) and network entities in communication over one or more cells.

FIG. 2 is a diagram illustrating a machine learning (ML)-based spatial-domain beam prediction procedure.

FIG. 3 is a diagram illustrating an ML-based time-domain beam prediction procedure.

FIG. 4 illustrates a signaling diagram for signaling between a network entity and a UE device for beam-codebook based beam prediction, in accordance with aspects of the present disclosure.

FIG. 5 illustrates a signaling diagram for signaling between a network entity and a UE device for beam-codebook based beam prediction, in accordance with aspects of the present disclosure.

FIG. 6 is a flowchart of a method of wireless communication corresponding to the signaling diagram of FIG. 4 at a UE device.

FIG. 7 is a flowchart of a method of wireless communication corresponding to the signaling diagram of FIG. 4 at a network entity.

FIG. 8 illustrates a signaling diagram for signaling between a network entity and a UE device for beam-codebook based beam prediction, in accordance with aspects of the present disclosure.

FIG. 9 illustrates a signaling diagram for signaling between a network entity and a UE device for beam-codebook based beam prediction, in accordance with aspects of the present disclosure.

FIG. 10 illustrates a signaling diagram for signaling between a network entity and a UE device for beam-codebook based beam prediction, in accordance with aspects of the present disclosure.

FIG. 11 is a flowchart of a method of wireless communication corresponding to the signaling diagram of FIG. 10 at a UE device.

FIG. 12 is a flowchart of a method of wireless communication corresponding to the signaling diagram of FIG. 10 at a network entity.

FIG. 13 is a flowchart of a method of wireless communication at a UE.

FIG. 14 is a flowchart of a method of wireless communication at a network entity.

FIG. 15 is a diagram illustrating a hardware implementation for an example UE device.

FIG. 16 is a diagram illustrating a hardware implementation for one or more example network entities.

### DETAILED DESCRIPTION

The present disclosure provides methods and techniques for signaling beam codebook based beam prediction, to maintain a common, same, or updated understandings between a network entity and a user equipment (UE) device on assumptions about a beam grid (e.g., a grid of beams formable or transmittable by the network entity and/or the UE device). The signaling indicates a beam codebook based beam grid assumptions, as the UE device often does not know about the beam grid of the network entity. The UE device reports measured and predicted beams to the network entity based on the beam codebook signaled by the network entity.

When the beam grid assumptions on the UE device side and on the network entity side mismatch, beam prediction accuracies deteriorate. To avoid such mismatch, the present disclosure provides techniques for using beam codebook to maintain the same understanding or assumptions about the beam grid on both the UE device side and the network entity side. For example, a UE device might support a number of beam grid assumptions configurations. The network entity may indicate which beam grid assumption is proper (e.g., based on the network antenna structure, power, etc.). The network entity may update the beam grid (e.g., the number of beams, width of beams, etc.) from time to time. The beam grid assumptions may be represented or associated with a beam codebook, which may be configured by the network entity or reported by the UE device.

By maintaining the same understanding between the network entity and the UE device on beam grid assumptions on the network entity side, the present disclosure improves beam prediction accuracy, such as, for machine learning (ML) based beam prediction. By increasing the beam prediction accuracy, the wireless performance of the network-UE pair improves because the accurate beam prediction reduces reference signal overhead for beam measurement (which has been primarily relied on to identify the best gNB-UE beam pair).

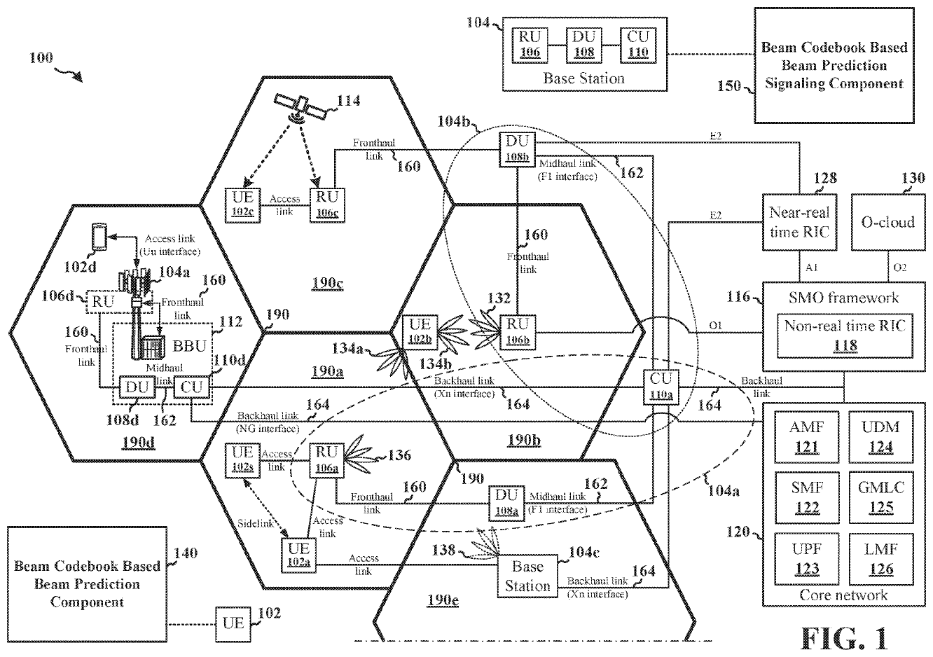

FIG. 1 illustrates a diagram 100 of a wireless communications system associated with a plurality of cells 190. The wireless communications system includes user equipments (UEs, or UE devices) 102 and base stations (or network entities) 104, where some base stations 104c include an aggregated base station architecture and other base stations 104a-104b include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CUI 110, or alternatively, may be geographically or virtually distributed throughout one or multiple other RAN nodes. The DUs 108 may be implemented to communicate with one or more RUs 106. Each of the RU 106, the DE 108 and the CU 110 can be implemented as virtual units, such as a virtual radio unit (VRU), a virtual distributed unit (VDU), or a virtual central unit (VCU). A base station 104 and/or a unit of the base station 104, such as the RU 106, the DU 108, or the CU 110, may be referred to as a transmission reception point (TR P).

Operations of the base stations 104 and/or network designs may be based on aggregation characteristics of base station functionality. For example, disaggregated base station architectures are utilized in an integrated access backhaul (LAB) network, an open-radio access network (O-RAN) network, or a virtualized radio access network (vRAN) which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the CU 110a communicates with the DUs 108a-108b via respective midhaul links 162 based on F1 interfaces. The DUs 108a-108b may respectively communicate with the RU 106a and the RUs 106b-106c via respective fronthaul links 160. The RUs 106a-106c may communicate with respective UEs 102a-102c and 102s via one or more radio frequency (RF) access links based on a Uu interface. In examples, multiple RUs 106 and/or base stations 104 may simultaneously serve the UEs 102, such as the UE 102a of the cell 190a that the access links for the RU 106a of the cell 190a and the base station 104c of the cell 190e simultaneously serve.

One or more CUs 110, such as the CU 110 a or the CU 110d, may communicate directly with a core network 120 via a backhaul link 164. For example, the CU 110d communicates with the core network 120 over a backhaul link 164 based on a next generation (NG) interface. The one or more CUs 110 may also communicate indirectly with the core network 120 through one or more disaggregated base station units, such as a near-real time RAN intelligent controller (RIC) 128 via an E2 link and a service management and orchestration (SMO) framework 116, which may be associated with a non-real time RIC 118. The near-real time RIC 128 might communicate with the SMO framework 116 and/or the non-real time RIC 118 via an A1 link. The SMO framework 116 and/or the non-real time RIC 118 might also communicate with an open cloud (O-cloud) 130 via an O2 link. The one or more CUs 110 may further communicate with each other over a backhaul link 164 based on an Xn interface. For example, the CU 110d of the base station 104c communicates with the CU 110a of the base station 104b over the backhaul link 164 based on the Xn interface. Similarly, the base station 104c of the cell 190e may communicate with the CU 110a of the base station 104b over a backhaul link 164 based on the Xn interface.

The RUs 106, the DUs 108, and the CUs 110, as well as the near-real time RIC 128, the non-real time RIC 118, and/or the SMO framework 116, may include (or couple to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as for the fronthaul link 160 between the RU 106d and the baseband unit (BBU) 112 of the cell 190d or, more specifically, the fronthaul link 160 between the RU 106d and DU 108d. The BBU 112 includes the DU 108d and a CU 110d, which may also have a wired interface configured between the DU 108d and the CU 110d to transmit or receive the information/signals between the DU 108d and the CU 110d based on a midhaul link 162. In further examples, a wireless interface, which may include a receiver, a transmitter, or a transceiver (such as an RF transceiver), can be configured to transmit or receive the information/signals via the wireless transmission medium, such as for information communicated between the RU 106a of the cell 190a and the base station 104c of the cell 190e via cross-cell communication beams of the RU 106a and the base station 104c.

One or more higher layer control functions, such as function related to radio resource control (RRC), packet data convergence protocol (PDCP), service data adaptation protocol (SDAP), and the like, may be hosted at the CU 110. Each control function may be associated with an interface for communicating signals based on one or more other control functions hosted at the CU 110. User plane functionality such as central unit-user plane (CU-UP) functionality, control plane functionality such as central unit-control plane (CU-CP) functionality, or a combination thereof may be implemented based on the CU 110. For example, the CU 110 can include a logical split between one or more CU-UP procedures and/or one or more CU-CP procedures. The CU-UP functionality may be based on bidirectional communication with the CU-CP functionality via an interface, such as an E1 interface (not shown), when implemented in an O-RAN configuration.

The CU 110 may communicate with the DU 108 for network control and signaling. The DU 108 is a logical unit of the base station 104 configured to perform one or more base station functionalities. For example, the DU 108 can control the operations of one or more RUs 106. One or more of a radio link control (RLC) layer, a medium access control (MAC) layer, or one or more higher physical (PHY) layers, such as forward error correction (FEC) modules for encoding/decoding, scrambling, modulation/demodulation, or the like can be hosted at the DU 108. The DU 108 may host such functionalities based on a functional split of the DU 108. The DU 108 may similarly host one or more lower PHY layers, where each lower layer or module may be implemented based on an interface for communications with other layers and modules hosted at the DU 108, or based on control functions hosted at the CU 110.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RUs 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or cross-cell communication beams. For example, the UE 102b of the cell 190b may communicate with the RU 106a of the cell 190a via a third set of communication beams 134a of the UE. 102b and an RU beam set 136 of the RU 106a. Both real-time and non-real-time features of control plane and user plane communications of the RUs 106 can be controlled by associated DUs 108. Accordingly, the DUs 108 and the CUs 110 can be utilized in a cloud-based RAN architecture, such as a vRAN architecture, whereas the SMO framework 116 can be utilized to support non-virtualized and virtualized RAN network elements. For non-virtualized network elements, the SMO framework 116 may support deployment of dedicated physical resources for RA coverage, where the dedicated physical resources may be managed through an operations and maintenance interface, such as an O1 interface. For virtualized network elements, the SMO framework 116 may interact with a cloud computing platform, such as the O-cloud 130 via the 02 link (e.g., cloud computing platform interface), to manage the network elements. Virtualized network elements can include, but are not limited to, RUs 106, DUs 108, CUs 110, near-real time RICs 128, etc.

The SMO framework 116 may be configured to utilize an 01 link to communicate directly with one or more RUs 106. The non-real time RIC 118 of the SMO framework 116 may also be configured to support functionalities of the SMO framework 116. For example, the non-real time RIC 118 implements logical functionality that enables control of non-real time RAN features and resources, features/applications of the near-real time RIC 128, and/or artificial intelligence/machine learning (AI/ML) procedures. The non-real time RIC 118 may communicate with (or be coupled to) the near-real time RIC 128, such as through the A1 interface. The near-real time RIC 128 may implement logical functionality that enables control of near-real time RAN features and resources based on data collection and interactions over an E2 interface, such as the E2 interfaces between the near-real time RIC 128 and the CU 110a and the DU 108b.

The non-real time RIC 118 may receive parameters or other information from external servers to generate AI/machine learning models for deployment in the near-real time RIC 128. For example, the non-real time RIC 118 receives the parameters or other information from the O-cloud 130 via the 02 link for deployment of the AI/machine learning models to the real-time RIC 128 via the A1 link. The near-real time RIC 128 may utilize the parameters and/or other information received from the non-real time RIC 118 or the SMO framework 116 via the A1 link to perform near-real time functionalities. The near-real time RIC 128 and the non-real time RIC 118 may be configured to adjust a performance of the RAN. For example, the non-real time RIC 118 monitors patterns and long-term trends to increase the performance of the RAN. The non-real time RIC 118 may also deploy AI/machine learning models for implementing corrective actions through the SMO framework 116, such as initiating a reconfiguration of the 01 link or indicating management procedures for the A1 link.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to the core network 120. That is, the base stations 104 might relay communications between the UEs 102 and the core network 120. The base stations 104 may be associated with macrocells for high-power cellular base stations and/or small cells for low-power cellular base stations. For example, the cell 190e corresponds to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104c of cell 190d to transmit a downlink/forward link communication to the UE 102d or receive an uplink/reverse link communication from the UE 102d based on the Uu interface associated with the access link between the UE 102d and the base station 104c/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer earners may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Tenn Evolution (LTE) systems, New Radio (N-R) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FRI) and frequency range 2 (FR2). FR1 ranges from 410 MHz-7.125 GHz and FR2 ranges from 24.25 GHz-71.0 GHz, which includes FR2-1 (24.25 GHz-52.6 GHz) and FR2-2 (52.6 GHz-71.0 GHz). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHz, FR4, which ranges from 71.0 GHz-114.25 GHz, and FRS, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHz, within FRI, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of beams 132 to the UE 102b in one or more transmit directions of the RU 106b. The UE 102b may receive the downlink beamformed signal based on a second set of beams 134b from the RU 106b in one or more receive directions of the UE 102b. In a further example, the UE 102b may also transmit an uplink beamformed signal to the RU 106b based on the second set of beams 134b in one or more transmit directions of the UE 102b. The RU 106b may receive the uplink beamformed signal from the UE 102b in one or more receive directions of the RU 106b. The UE 102b may perform beam training to determine the best receive and transmit directions for the beam formed signals. The transmit and receive directions for the UEs 102 and the base stations 104/RUs 106 might or might not be the same. In further examples, beamformed signals may be communicated between a first base station 104c and a second base station 104b. For instance, the RU 106a of cell 190a may transmit a beamformed signal based on the RU beam set 136 to the base station 104c of cell 190e in one or more transmit directions of the RU 106a. The base station 104c of the cell 190c may receive the beamformed signal from the RU 106a based on a base station beam set 138 in one or more receive directions of the base station 104c. Similarly, the base station 104c of the cell 190e may transmit a beamformed signal to the RU 106a based on the base station beam set 138 in one or more transmit directions of the base station 104c. The RU 106a may receive the beamformed signal from the base station 104c of the cell 190e based on the RU beam set 136 in one or more receive directions of the RU 106a.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station with an RU 106 and a BBU that includes a DU 108 and a CU 110, or as a disaggregated base station 104b including one or more of the RU 106, the DU 108, and/or the CU 110. A set of aggregated or disaggregated base stations 104a-104b may be referred to as a next generation-radio access network (NG-RAN). In some examples, the UE 102b operates in dual connectivity (DC) with the base station 104a and the base station 104b. In such cases, the base station 104a can be a master node and the base station 104b can be a secondary node. In other examples, the UE 102b operates in DC with the DU 108a and the DU 108b. In such cases, the DU 108a can be the master node and the DU 108b can be the secondary node.

The core network 120 may include an Access and Mobility Management Function (AMF) 121, a Session Management Function (SMF) 122, a User Plane Function (UPF) 123, a Unified Data Management (UDM) 124, a Gateway Mobile Location Center (CMLC) 125, and/or a Location Management Function (LMF) 126. The core network 120 may also include one or more location servers, which may include the GMLC 125 and the LMF 126, as well as other functional entities. For example, the one or more location servers include one or more location/positioning, servers, which may include the GMLC 125 and the LNMF 126 in addition to one or more of a position determination entity (PDE), a serving mobile location center (SMLC), a mobile positioning center (MPC), or the like.

The AMF 121 is the control node that processes the signaling between the UEs 102 and the core network 120. The AMF 121 supports registration management, connection management, mobility management, and other functions. The SMF 122 supports session management and other functions. The UPF 123 supports packet routing, packet forwarding, and other functions. The UDM 124 supports the generation of authentication and key agreement (AKA) credentials, user identification handling, access authorization, and subscription management. The GMLC 125 provides an interface for clients/applications (e.g., emergency services) for accessing UE positioning information. The LMF 126 receives measurements and assistance information from the NG-RAN and the UEs 102 via the AMF 121 to compute the position of the UEs 102. The NG-RAN may utilize one or more positioning methods in order to determine the position of the UEs 102. Positioning the UEs 102 may involve signal measurements, a position estimate, and an optional velocity computation based on the measurements. The signal measurements may be made by the UEs 102 and/or the serving base stations 104/RUs 106.

Communicated signals may also be based on one or more of a satellite positioning system (SPS) 114, such as signals measured for positioning. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NT N), or other satellite position/location system. The SPS 114 may be associated with LTE signals, NR signals (e.g., based on round trip time (RTT) and/or multi-RT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

The UEs 102 may be configured as a cellular phone, a smart phone, a session initiation protocol (SIP) phone, a laptop, a personal digital assistant (PDA), a satellite radio, a GPS, a multimedia device, a video device, a digital audio player (e.g., moving picture experts group (MPEG) audio layer-3 (MP3) player), a camera, a game console, a tablet, a smart device, a wearable device, a vehicle, an utility meter, a gas pump, appliances, a healthcare device, a sensor/actuator, a display, or any other device of similar functionality. Some of the UEs 102 may be referred to as Internet of Things (IoT) devices, such as parking meters, gas pumps, appliances, vehicles, healthcare equipment, etc. The UE 102 may also be referred to as a station (STA), a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wire less terminal, a remote terminal, a handset, a mobile client, a client, or other similar terminology. The term UE may also apply to a roadside unit (RSU), which may communicate with other RSU UEs, non-RSU UEs, a base station 104, and/or an entity at a base station 104, such as an RU 106.

Still referring to FIG. 1, in certain aspects, the UE 102 may include a beam codebook based beam prediction component 140 configured to receive, from the base station 104, a first control signaling that includes at least one beam codebook representing beam-related assumptions; and a first set of parameters for a predicted beam report. The beam codebook based beam prediction component 140 of the UE 102 measures quality of downlink reference signals from the network entity and generates a beam prediction using the at least one beam codebook, to predict quality of beams transmittable by the network entity, based on the measured quality of the downlink reference signals. The beam codebook based beam prediction component 140 causes the UE 102 to transmit, to the network entity, the predicted beam report based on the beam prediction and generated according to the first set of parameters.

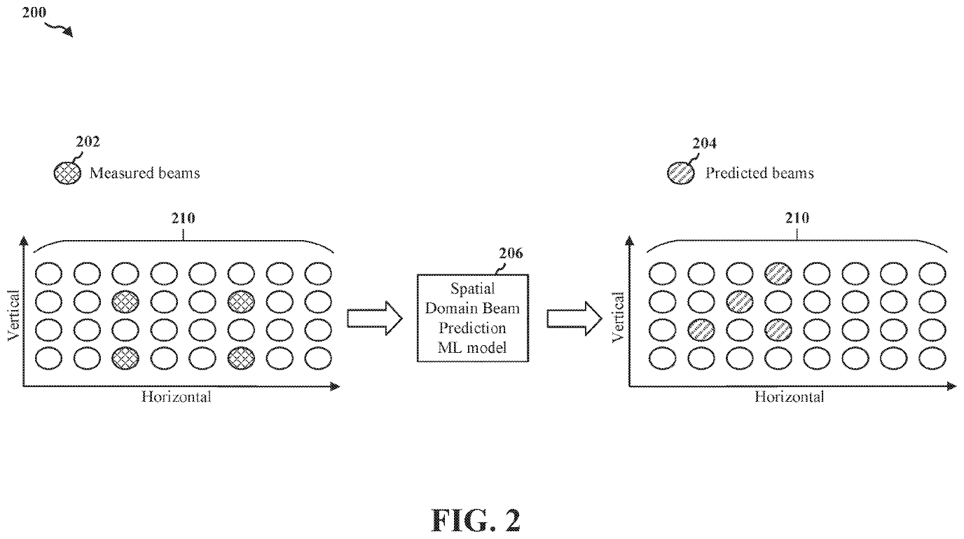

In certain aspects, the base station 104 or a network entity of the base station 104 may include a beam codebook based beam prediction signaling component 150 configured to transmit, to the UE 102, a first control signaling that includes at least at least one beam codebook representing beam-related assumptions and a first set of parameters for a predicted beam report. The beam codebook based beam prediction signaling component 150 causes the base station 104 to transmit the downlink reference signals to the UE device based on the beam information in the first control signaling and receive, from the UE 102, a predicted beam report based on beam prediction generated by the UE 102 using the at least one beam codebook to predict quality of beams transmittable by the base station 104 and based on the measured quality of the downlink reference signals. Accordingly, FIG. 1 describes a wireless communication system that may be implemented in connection with aspects of one or more other figures described herein, such as aspects illustrated in FIGS. 2-14. Further, although the following description may be focused on 5G NR, the concepts described herein may be applicable to other similar areas, such as 5G-Advanced and future versions, LTE, LTE-advanced (LTE-A), and other wireless technologies, such as 6G.

FIG. 2 is a diagram 200 illustrating an ML-based spatial-domain beam prediction procedure. As shown, a network entity (e.g., the base station 104) is capable of transmit a grid of beams 210. To identify, the best network beam among the possible beams 210 using an ML model 206, the UE 102 does not measure each beam. Instead, the UE 102 measures a first set of network beams 202 (e.g., L1-RSRP of the four beams 202). The measured beams 202 are provided as input to the trained ML model 206, which then predicts a second set of network beams 204 that have the highest possibility to be the best beam. Then the next beam measurement can be based on the predicted second set of network beams 204.

In general, in order to increase the link budget, the base station and the UE may perform an analog beamforming operation to activate a beam pair having an increased signal strength. Both the base station and the UE maintain multiple beams 210 that may be used for the beam pair. A beam pair that decreases a coupling loss might result in an increased coverage gain for the base station and the UE. “Coupling loss” refers to a path loss/reduction in power density between a first antenna of the base station and a second antenna of the UE, and may be indicated in units of decibel (dB). Beam selection procedures from the plurality of beams 210 for activation of the beam pair by the base station and the UE might be associated with one or more of beam measurements (e.g., measured beams 202), beam reporting, or beam indication/prediction (e.g., predicted beams 204).

A first type of beam reporting might correspond to non-group based beam reporting, where the base station can configure the UE to measure and report at least one L1-RSRP or at least one L1-SINR for a set of downlink reference signals from the base station. The downlink reference signals may correspond to synchronization signal blocks (SSBs), Channel State Information Reference Signals (CST-RSs), etc. The UE might report the L1-RSRP or the L1-SINR in each beam reporting instance for up to 4 SSBs or 4 CSI-RSs. A second type of beam reporting might correspond to group-based beam reporting, where the base station can configure the UE to measure and report the L1-RSRP or the L1-SINR for multiple groups of SSBs or CSI-RSs. Each beam group may include 2 SSBs or 2 CSI-RSs that that the UE can receive simultaneously.

Beam indication techniques based on TCI signaling may include joint beam indication or separate beam indications. “Joint beam indication” refers to a single/joint TCI state that is used to update the beams 210 for both the downlink channels/signals and the uplink channels/signals. For example, the base station can indicate a single/joint TCI state in downlink TCI signaling that is configured based on a DLorJointTCIState parameter to update the beams 210 for both the downlink channels/signals and the uplink channels/signals. For TCI signaling based on the joint TCI state, the base station may transmit an SSB or CST-RS to indicate the QCL relationship between the downlink channels/signals and a spatial relation of the uplink channels/signals. In a first aspect, the transmitted TC update signaling may correspond to a joint beam indication for both the downlink channels/signals and the uplink channels/signals.

“Separate beam indications” refers to a first TCI state that is used to update a first beam for the downlink channels/signals and a second TCI state that is used to update a second beam for the uplink channels/signals. For example, the base station can indicate the first TC state in the downlink TCI signaling configured based on the DnLorJointTCIState parameter to update the first beam for the downlink channels/signals, and may indicate the second TCI state in further downlink TCI signaling configured based on an UL-TCIState parameter to update the second beam for the uplink channels/signals. If the base station indicates the second TCI state (e.g., uplink TCI), the downlink reference signal may correspond to the SSB, the CST-RS, etc. In examples where the second TCI state indicates an uplink reference signal (e.g., uplink TCI), the uplink reference signal may correspond to a sounding reference signal (SRS), which might indicate the spatial relation of the uplink channels/signals. In a second aspect, the transmitted TCI update signaling may correspond to either the downlink channels/signals or the uplink channels/signals based on the separate beam indications technique.

The base station may configure a QCL type and/or a source reference signal for the QCL signaling. QCL types for downlink reference signals might be based on a higher laver parameter, such as a qcl-Type in a QCL-Info parameter. A first QCL type that corresponds to typeA might be associated with a Doppler shift, a Doppler spread, an average delay, and/or a delay spread. A second QCL type that corresponds to typeB might be associated with the Doppler shift and/or the Doppler spread. A third QCL type that corresponds to typeC might be associated with the Doppler shift and/or the average delay. A fourth QCL type that corresponds to typeD might be associated with a spatial receive (Rx) parameter. The UE may use a same spatial transmission filter to indicate the spatial relation as used to receive the downlink reference signal from the base station or transmit the uplink reference signal. The transmitted TCI update signaling updates the TCI state for the channels of a component carrier (CC) that share the TCI state indicted in the TC update signaling. The CC might be associated with a cell included in a cell list. The cell list is configured vian RRC signaling, which may indicate parameters such as a sinultaneousTCI-UpdateListl parameter, a simnuitaneousTC-UpdateList2 parameter, a simultaneousTCI-(UpdateList3 parameter, or a simultaneousTCI-UpdateList4 parameter.

Signaling communicated between the base station and the UE may be dedicated signaling or non-dedicated signaling. “Dedicated signaling” refers to signaling between the base station and the UE that is UE-specific. For example, dedicated signaling may correspond to a physical downlink control channel (PDCCH), a physical downlink shared channel (PDSCH), a physical uplink control channel (PUCCH), or a physical uplink shared channel (PUSCH) associated with the cell list that shares the indicated TCI state. PUSCH/PUCCH triggered at the UE by downlink control information (DCI), activated based on a medium access control-control element (MAC-CE), or configured based on an uplink grant in RRC signaling from the base station are dedicated signals.

“Non-dedicated signaling” refers to signaling between the base station and a non-specific UE. For example, non-dedicated signaling may correspond to physical broadcast channel (PBCH), PDCCH/PDSCH transmissions from the base station for non-specific UEs, aperiodic CSI-RS, or SRS for codebook, non-codebook, or antenna switching. PDCCH in a control resource set (CORESET) associated with Types 0/0A/0B/1/2 common search spaces, and PDSCH scheduled by such PDCCH are non-dedicated signals. However, other PDCCH and PDSCH signaling may be dedicated signals. The search space type might be defined based on standardized protocols.

The machine learning model 206 can be implemented at either the base station or the UE to predict a top N beams (e.g., predicted beams 204) in the grid of beams 210 that might have a highest beam quality in the grid of beams 210. As mentioned above, the machine learning model 206 may determine the predicted beams 204 without the UE measuring the beam quality of every beam in the grid of beams 210.

For example, the UE might measure a first set of measured beams 202 in the grid of beams 210. Beam measurements, such as L1-RSRP and/or L1-SINR measurements, for a subset of beams in the grid of beams 210 can be input to the machine learning model 206 to generate the prediction of the top N beams (e.g., predicted beams 204) in the grid of beams 210 that are most likely to have the highest beam quality in the grid of beams 210. An example ML-based spatial domain beam prediction may include inputting L1-RSRP measurement results of a first set of beams (e.g., the four measured beams 202) into the machine learning model 206, which may output a second set of predicted beams 204 (e.g., the four predicted beams 204 that are different from the four measured beams 202) that are likely to be of the highest beam quality in the grid of beams 210. A next beam measurement procedure may therefore be based or focused on the second set of predicted beams 204.

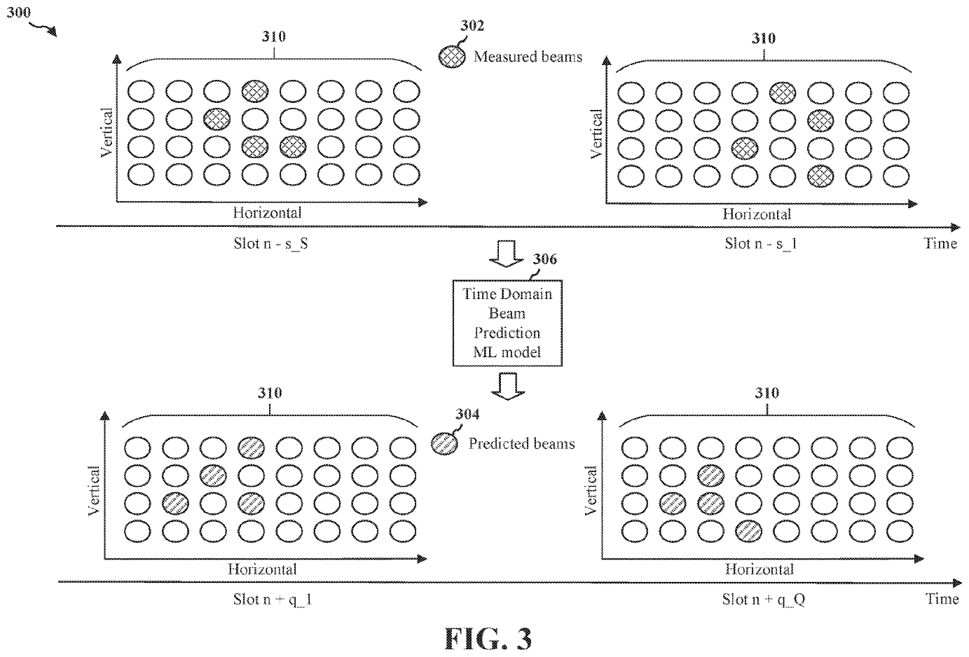

FIG. 3 is a diagram 300 illustrating an ML-based time-domain beam prediction procedure. Similar to the spatial domain beam prediction discussed above, the UE 102 need not measure every beam in the grid of beams 310 transmittable by the network entity 104. As shown, based on the L1-RSRP from the reported beams 302 in a first set of time instances in the past, e.g., beam report in the slots n−ss, n−ss−1, . . . , n−s1, the trained ML model 306 predicts the beams 304 in the second set of time instances in the future, e.g., predicted beams 304 in the slots n+q1, n+q2, . . . , n+qQ.

Referring to both FIGS. 2 and 3, the ML training and inference of the ML models 206 and 306 may either be on the network entity side or the UE side. For example, either the UE device 102 or the network entity 104 may use an ML model for beam prediction and selection. According to some aspects of the present disclosure, the UE device 102 performs ML training and interference. When the ML model 206 or 306 is deployed on the UE side, as the UE may not aware the network entity beam grid when it performs the ML training, e.g., offline training, the UE may perform the beam prediction with a mismatched beam grid compared to the actual beam grid in the network entity side.

As shown below in Table 1, the beam prediction accuracy depends on whether beam grid assumptions on the UE side match the reality on the network side. That is, when the beam grid assumptions do not match reality, the beam grid for ML training/interference is different from the actual beam grid of the network entity, even is the beam grid assumptions of the ML model use the same number of beams. For example, the actual beam grid may be characterized by or based on different horizontal and vertical direction spans.

Assume that the ML model is based on the horizontal beams from −60 degree to 60 degree, and vertical beams from 100 degree to 160 degree. If the beam grid used by the ML model matches reality of the beam grid used on the network entity side the ML model prediction accuracy for top beam, top 2 beams, top 4 beams and top 8 beams is shown in the middle column of Table 1. However, if there is a beam grid mismatch, e.g., the actual horizontal beam span in the network entity is from −70 degree to 70 degree and the actual vertical beam span in the network entity is from 80 degree to 160 degree (thus, being different from the spans presumed by the ML model), the prediction accuracy (shown in the right-side column of Table 1) is significantly degraded. In other words, beam prediction accuracy without beam grid mismatch is significantly higher than the accuracy of with beam grid mismatch. The predicted top-N beams (N=1, 2, 4, 8) are counted as correct if the L1-RSRP for the best beam among the top-N beams is larger than the L1-RSRP from the ideal beam minus 1 dB margin.

TABLE 1
Simulation results for spatial-domain beam prediction
accuracy with and without beam grid mismatch

| | Without beam | With beam |
|---|---|---|
| Predicted beam | grid mismatch | grid mismatch |
| Top-1 | 47.98% | 11.53% |
| Top-2 | 65.49% | 20.32% |
| Top-4 | 82.09% | 40.64% |
| Top-8 | 93.62% | 63.38% |

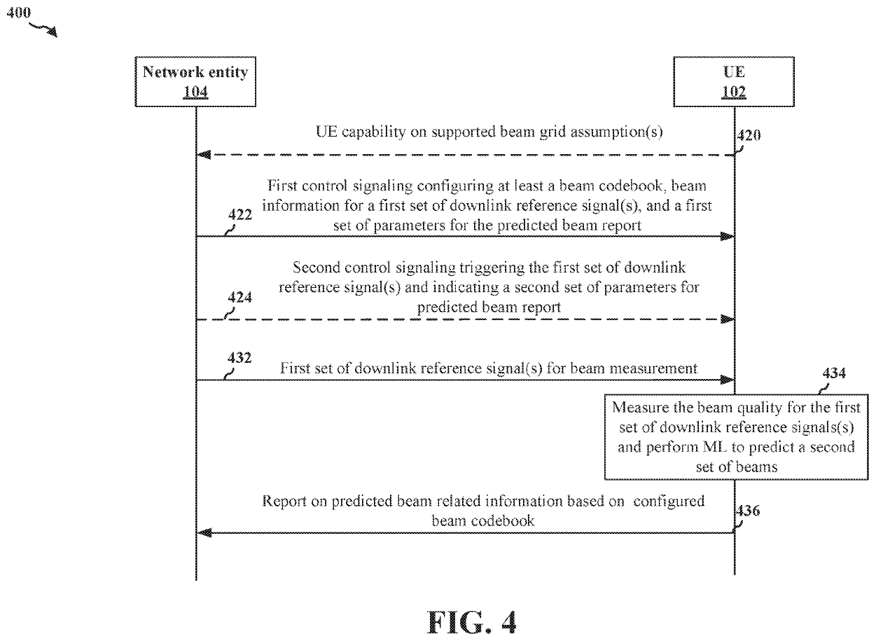

Therefore, beam grid mismatch between the real network beam grid and the beam grid assumption in the ML model degrades beam prediction accuracy. The present disclosure provides methods and techniques for maintaining a good understanding between the network entity 104 and the UE device 102 relative to the assumptions related to the beam grid for ML-based beam prediction, thus avoiding beam prediction degradation caused by the beam grid mismatch. In addition, the methods and techniques provided by the present disclosure improve beam management performance when the network entity 104 updates the beam selected for power saving, coverage, load balancing, among other aspects, by using the ML beam predictions based on a real or at least realistic understanding of beam grid. Accordingly, FIGS. 4-14 provide various examples for signaling beam codebook used by the UE when the ML model generates beam predictions, between the network entity 104 and the UE device 102.

FIG. 4 illustrates a signaling diagram 400 for signaling between network entity 104 and UE 102 for beam-codebook based beam prediction, in accordance with aspects of the present disclosure. In this example, the network entity 104 selects a beam codebook. For example, the UE 102 reports 420 one or more capabilities on the supported beam grid assumptions to the network entity. In some implementations, the one or more capabilities may indicate the supported beam codebooks, antenna architecture assumptions, number of measured beams and number of predicted beams. In some examples, the network entity 104 receives the one or more capabilities from a core network (e.g., Access and Mobility Management Function (AMF)) or another network entity. Based on the received one or more capabilities, the network entity may transmit a first control signaling configuring at least one beam codebook, a first set of downlink reference signal(s), e.g., SSB/CSI-RS, for beam measurement as the input for ML, and a first set of parameters for predicted beam report.

The network entity 104 transmits 422 the first control signaling by RRC message(s), e.g., RRCReconfiguration. The network entity may further transmit 424 a second control signaling by MAC control element (CE) or downlink control information (DCI). The network entity may transmit 424 the second control signaling indicating a second set of parameters for predicted beam report and triggering the first set of downlink reference signal(s). In one example, for semi-persistent CSI-RS, the network entity transmits the second control signaling by MAC CE. In another example, for aperiodic CSI-RS, the network entity transmits the second control signaling by DCI.

As shown, the network entity 104 transmits 432 the first set of downlink reference signal(s). In some examples, the network entity may transmit 432 the first set of downlink reference signal(s) before transmitting 424 the second control signaling. The network entity 104 may transmit subsequent sets of downlink reference signals if needed (e.g., when the first set of downlink reference signals is insufficient for beam prediction).

The UE measures 434 the first set of downlink reference signal(s) and performs the ML based beam prediction with the measured beam quality from the first set of downlink reference signal(s) as input. Then the UE transmits 436 predicted beam report to the network, which at least indicates the predicted beam information based on the configured beam codebook.

Examples for the beam codebook are provided below. The beam codebook may be defined using antenna phase offset or digital Fourier transform (DFT) vectors. For example, an antenna phase offset based beam codebook is generated based on a set of beams, where one of the beams, e.g., beam k, is generated based on the phase offset between network entity antennas at a transmission direction k.

$$\begin{matrix}{B}_{k} = [ {w}_{0 , 0} , {w}_{1 , 0} , … , {w}_{{N}_{1} - 1 , 0} , \\ {w}_{0 , 1} , {w}_{1 , 1} , … {w}_{{N}_{1} - 1 , 1} , … , \\ {{w}_{0 , {N}_{2} - 1} , {w}_{1 , {N}_{2} - 1} , … , {w}_{{N}_{1} - 1 , {N}_{2} - 1} ]}^{T}\end{matrix}$$

$${w}_{m , n} = \frac{1}{\sqrt{{N}_{1} {N}_{2}}} exp \{ - j \frac{2 π}{λ} [ ( m - 1 ) {γ}_{H} sin {θ}_{i} sin {φ}_{k} - ( n - 1 ) {γ}_{V} cos {θ}_{k} ] \}$$

where, N₁ indicates the number of horizontal antenna elements/ports; N₂ indicates the number of vertical antenna elements/ports; λ indicates the waveform length; γ_{H} indicates the antenna spacing in horizontal domain. γ_{V}, indicates the antenna spacing in vertical domain; θₖ is the vertical direction for the beam k and φₖ is the horizontal direction for beam k.

A DFT based beam codebook is generated based on a set of beams generated based on Digital Fourier Transform (DFT) vectors. In an example, the beam k can be generated based on different value of n and n as follows:

$${B}_{k} = \frac{1}{\sqrt{{N}_{1} {N}_{2}}} \{ {u}_{m} ⊗ {v}_{n} \}$$

$${u}_{m} = {[ \begin{matrix}1 & {e}^{\frac{j 2 π m}{{N}_{1} {O}_{1}}} & … & {e}^{\frac{j 2 π ( {N}_{1} - 1 ) m}{{N}_{1} {O}_{1}}}\end{matrix} ]}^{T}$$

$${v}_{m} = {[ \begin{matrix}1 & {e}^{\frac{j 2 π m}{{N}_{2} {O}_{2}}} & … & {e}^{\frac{j 2 π ( {N}_{2} - 1 ) m}{{N}_{2} {O}_{2}}}\end{matrix} ]}^{T}$$

where, N₁ indicates the number of horizontal antenna elements/ports; N₂ indicates the number of vertical antenna elements/ports; O₁ indicates the oversampling factor in horizontal domain; O₂ indicates the oversampling factor in vertical domain.

When the UE 102 transmits 420 the UE capability to the network entity 104, the UE capability examples include indications of supported beam grid assumption(s) and supported antenna assumption(s). For antenna phase offset based beam codebook provided above, beam grid assumptions include at least one of: horizontal angle span for the beam grid; number of horizontal beams; vertical angle span for the beam grid; number of vertical beams; vertical and horizontal angle for each beam; and antenna assumptions. The antenna assumptions include at least one of the elements: number of horizontal antenna elements/ports; number of vertical antenna elements/ports; antenna spacing in vertical domain; antenna spacing in horizontal domain.

For DFT based beam codebook provided above, beam grid assumptions include at least one of: oversampling factor in horizontal domain; oversampling factor in vertical domain. The antenna assumption includes at least one of the elements: number of horizontal antenna elements/ports; number of vertical antenna elements/ports.

In some implementations, the UE may further transmit one or more than one UE capabilities indicating at least one of the elements for one or more than supported beam grid: the minimal number of downlink reference signals for beam prediction, the maximum number of downlink reference signals for beam prediction, the maximum number of downlink reference signals in a slot for beam prediction, the minimal number of predicted beams to identify the best beam, the maximum number of predicted beams to identify the best beam, and the preferred beams for measurement. The one or more capabilities above may be counted per component carrier (CC), per band, per band combination or per UE. The one or more capabilities above may be reported per feature set, per band, per band combination or per UE.

When the UE 102 receives 422 the first signaling from the network entity 104, the first signaling may be a radio resource control (RRC) signaling, such as CSI-ReportConfig. The RRC signaling may include one or more of the following parameters. For example, the RRC signaling may include a set of parameters for beam codebook. For antenna phase offset based beam codebook, the set of parameters for beam codebook include at least one parameter indicating the number of horizontal antenna elements/ports, number of vertical antenna elements/ports, antenna spacing in vertical domain, antenna spacing in horizontal domain, horizontal angle span for the beam grid, number of horizontal beams, vertical angle span for the beam grid, and/or number of vertical beams. For DFT based beam codebook, the set of parameters for beam codebook include at least one parameter indicating the number of horizontal antenna elements/ports, number of vertical antenna elements/ports, oversampling factor in horizontal domain, oversampling factor in vertical domain.

The RRC signaling may include a beam codebook subset restriction indicating the subset of beams in the beam codebook subset used for beam information indication and/or predicted beam information report. In one example, for a beam codebook with K beams, the beam codebook subset restriction may indicate only K′(K′<K) beams among the K beams are valid for beam information indication and/or predicted beam information report.

The RRC signaling may include a list of channel measurement resource (CMR) configuring the first set of downlink reference signals, e.g., SSB/CSI-RS, for beam measurement.

The RRC signaling may include a report quantity indicating the report quantity for the predicted beams (e.g., a number/quantity of predicted beam reports). In some implementations, the network entity may indicate the UE to report beam matrix indicator (BMI) for the predicted beam(s) based on the beam codebook. In some examples, the network entity may indicate the UE to report BMI and predicted RSRP/SINR for the predicted beam(s). In some examples, the network entity may indicate the UE to report BMI and beam predication accuracy for the predicted beam(s). In some examples, the network entity may indicate the UE to report BMI, RSRP/SINR, and beam prediction accuracy for the predicted beam(s).

The RRC signaling may include BMI for each CMR indicating the beam index within the configured beam codebook for each CMR. The RRC signaling may include a first threshold indicating the beam prediction accuracy threshold. The RRC signaling may include a second threshold indicating the predicted L1-RSRP/L1-SINR threshold.

In one example, the network entity may configure the RRC parameters in a CST-ReportConfig as follows. The network entity configures the beam codebook by beanCodebookConfig. For each beam codebook configuration, the network entity further configures the antenna structure and beams by n1-n2, and the indication of the value of n1-n2 can be predefined. The network entity can configure the beam codebook subset restriction by beamnCodebookSubsetRestriction. In one example, each bit of the parameter beamCodebookSubsetRestriction corresponds to a beam, where value “I” indicates the beam is valid for beam indication and report and value “0” indicates the beam is invalid for beam indication and report. In addition, the network entity may configure the beam codebook generation scheme by beamCodebookMode. The network entity can indicate the BMI for each CSI-RS resource or CSI-RS resource set configured as CMR by bmiListCsiRs, and indicate the BMI for each SSB configured as CMR by bmiListSsb.

The network entity can configure different report quantity by setting different value of reportQuantity. The network entity can indicate the UE to report PMI for the predicted beam(s) based on the beam codebook by setting reportQuantity=bmi. The network entity can indicate the IE to report BMI and predicted RSRP/SINR for the predicted beam(s) by setting reportQuantity=bmi-RSRP or reportQuantity=bmi-SINR or reportQuantity=bmi-RSRP-SINR. The network entity may indicate the UE to report BMI and beam predication accuracy for the predicted beam(s) by setting reportQuantity-accuracy. The network entity can indicate the UE to report BMI, RSRP/SINR, and beam prediction accuracy for the predicted beam(s) by setting reportQuantity=bmi-RSRP-accuracy or reportQuantity=bmi-SINR-accuracy or reportQuantity=bmi-RSRP-SINR-accuracy. An example signaling message is provided below.

### Example Message

| CSI-ReportConfig ::= | SEQUENCE { | |
|---|---|---|
| reportConfigId | CSI-ReportConfigId, | |
| carrier | ServCellIndex OPTIONAL, -- Need S | |
| resourcesForChannelMeasurement | CSI-ResourceConfigId, | |
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |

| | |
|---|---|
| reportConfigType | CHOICE { |
| periodic | SEQUENCE { |
| resportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUSCH | SEQUENCE { |
| reportSlotConfig | ENUMERATED {s15, s110, s120, s140, s180, s1160, |

s1320},

| | |
|---|---|
| reportSlotOffsetList | SEQUENCE (SIZE (1.. maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL-Allocations)) OF |

```
INTEGER(0..32)
    }
  },
```

| reportQuantity | CHOICE { | |
|---|---|---|
| none | NULL, | |
| cri-RI-PMI-CQI | NULL, | |
| cri-RI-i1 | NULL, | |
| cri-RI-i1-CQI | SEQUENCE { | |
| pdsch-BundleSizeForCSI | ENUMERATED {n2, n4} | OPTIONAL - |

- Need S
},

| | |
|---|---|
| cri-RI-CQI | NULL, |
| cri-RSRP | NULL, |
| ssb-Index-RSRP | NULL, |
| cri-RI-LI-PMI-CQI | NULL, |
| bmi | NULL, |
| bmi-RSRP | NULL, |
| bmi-SINR | NULL, |
| bmi-RSRP-SINR | NULL, |
| bmi-accuracy | NULL, |
| bmi-RSRP-accuracy | NULL, |
| bmi-SINR-accuracy | NULL, |
| bmi-RSRP-SINR-accuracy | NULL, |

```
    },
    <unrelated part omitted>
```

| | | |
|---|---|---|
| beamCodebookConfig | BeamCodebookConfig | OPTIONAL, -- Need R |

}

| | |
|---|---|
| BeamCodebookConfig ::= | SEQUENCE { |
| antennaConfig | SEQUENCE { |
| n1-n2 | CHOICE { |
| four-four | BIT STRING (SIZE (16)), |
| eight-four | BIT STRING (SIZE (16)), |
| eight-eight | BIT STRING (SIZE (16)), |
| sixteen-four | BIT STRING (SIZE (8)), |
| sixteen-eight | BIT STRING (SIZE (8)), |

},

| | |
|---|---|
| beamCodebookRestriction | BIT STRING (SIZE (256)) |

}

| | |
|---|---|
| beamCodebookMode | INTEGER (1..2) |

}

| | |
|---|---|
| CSI-ResourceConfig ::= | SEQUENCE { |
| csi-ResourceConfigId | CSI-ResourceConfigId, |
| csi-RS-ResourceSetlist | CHOICE { |
| nzp-CSI-RS-SSB | SEQUENCE { |

nzp-CSI-RS-ResourceSetList SEQUENCE (SIZE (1..maxNrofNZP-CSI-RS-
ResourceSetsPerConfig)) OF NZP-CSI-RS-ResourceSetId

OPTIONAL, -- Need R

| | |
|---|---|
| csi-SSB-ResourceSetList | SEQUENCE (SIZE (1..maxNrofCSI-SSB- |

ResourceSetsPerConfig)) OF CSI-SSB-ResourceSetID OPTIONAL -- Need R

| | |
|---|---|
| bmiListCsiRs | SEQUENCE (SIZE (1..maxNrofNZP-CSI-RS-ResourceSetsPerConfig)) |

OF INTEGER (0..255) OPTIONAL -- Need R

| | |
|---|---|
| bmiListSsb | SEQUENCE (SIZE (1..maxNrofCSI-SSB-ResourceSetsPerConfig)) OF |

INTEGER (0..255) OPTIONAL -- Need R
},

| | |
|---|---|
| csi-IM-ResourceSetList | SEQUENCE (SIZE (1..maxNrofCSI-IM-ResourceSetsPerConfig)) OF |

CSI-IM-ResourceSetId
},

| | |
|---|---|
| bwp-Id | BWP-Id, |
| resourceType | ENUMERATED { aperiodic, semiPersistent, periodic }, |

```
  ...,
  [[
```

| | |
|---|---|
| csi-SSB-ResourceSetListExt-r17 | CSI-SSB-ResourceSetId |

OPTIONAL -- Need R
]]
}

In some examples, the network entity may transmit 424 at least one of the parameters above using the second control signaling, e.g., MAC CE or DCI. In one example, the network entity may transmit a MAC CE or DCI indicating the BMI for the first set of downlink reference signals.

The MAC CE or DCI may include at least one of the following parameters. The MAC CE or DCI may include a serving cell index indicating the serving cell index for the first set of downlink reference signal. The MAC CE or DCI may include a bandwidth part (BWP) index indicating BWP index for the first set of downlink reference signal. The MAC CE or DCI may include a resource set and/or resource index for the first set of downlink reference signal. The MAC CE or DCI may include a BMI for each reference signal in the first set of downlink reference signal.

In another example, the network entity may indicate the BMI for aperiodic downlink reference signal(s) in the first set by the DCI used to trigger the downlink reference signal(s). The network entity may configure different BMI corresponding to different triggering state by RRC signaling and indicate the PMI for the first set of downlink reference signals by indicating different triggering state in the DCI.

When the UE 102 receives 432 the downlink reference signals from the network entity 104 for beam measurement, the downlink reference signals may include channel state information (CSI) reference signals (RS). The network entity 104 may transmit N (N>1) CSI-RS resources set based on the UE capability on maximum/minimum number of measured beams for beam prediction, and the network entity may transmit M (M>1) CSI-R S resources with the same spatial domain filter in each CSI-RS resource set, e.g., the network entity configures the RRC parameter repetitions for each CSI-RS resource set. The UE measures one beam quality based on the M CSI-RS resources in each CSI-RS resource set. The UE may receive the CSI-RS resources based on UE beam sweeping operation.

In some cases, the network entity may transmit N (N>1) SSBs based on the UE capability on maximum/minimum number of measured beams for beam prediction, and the UE may receive the symbols in a SSB based on FE beam sweeping operation.

When the UE 102 transmits 436 the predicted beam report, the UE 102 reports a second set of predicted beam index(es) to the network entity by indicating a set of BMIs. In some implementations, the number of predicted beams in the second set is configured by the network entity by RRC signaling. In some examples, the number of predicted beams in the second set is reported by the UE 102.

The UE 102 may determine the number of predicted beams based on the predicted beam accuracy and the first threshold for predicted beam accuracy, and/or the predicted L1-RSRP/L1-SINR and the second threshold for the predicted L1-RSRP/L1-SINR. The UE only reports the beams with the predicted beam accuracy or predicted L1-RSRP/L1-SINR satisfying the report criteria, e.g., exceeding the first/second threshold.

In one example, the UE 102 reports the number of predicted beams in CSI part 1 and reports the set of BMIs in CSI part 2, where the payload size for the set of BMIs in CSI part 2 is based on the reported number of beams in CST part 1. In another example, the UE reports the number of predicted beams and the set of BMIs in the same CSI part, e.g., CSI part 1 or CSI part 2. In some implementations, the UE 102 may report the predicted beam index(es) in an order based on the predicted beam accuracy or predicted RSRP.

Table 2 below illustrates an example for the UE report, where the predicted beam accuracy or predicted RSRP for the reported beams is in the order of BMI1>BMI2> . . . >BMI N.

TABLE 2
An example for report format for N reported predicted beams

BMI 1
BMI 2
. . .
BMI N

In some cases, the U E 102 reports 436 a second set of predicted beam index(es) to the network entity by indicating a set of BMIs and reports the predicted RSRP and/or SINR for the reported predicted beams. In some implementations, the number of predicted beams in the second set is configured by the network entity by RRC signaling.

In some examples, the UE 102 reports the number of predicted beams in the second set. The UE 102 may determine the number of predicted beams based on the predicted beam accuracy and the first threshold for predicted beam accuracy, and/or the predicted L1-RSRP/L1-SINR and the second threshold for the predicted L1-RSRP/L1-SINR. The IE only reports the beams with the predicted beam accuracy or predicted L1-RSRP/L1-SINR satisfying the report criteria, e.g., exceeding the first/second threshold.

In one example, the TIE 102 reports the number of predicted beams in CSI part 1 and reports the set of BMIs in CSI part 2, where the payload size for the set of BMIs in CSI part 2 is based on the reported number of beams in CSI part 1. In another example, the UE reports the number of predicted beams and the set of BMIs in the same CSI part, e.g., CSI part 1 or CSI part 2. The UE 102 may report a bitmap indicating the number of predicted beams and the set of BMIs. The length of the bitmap is the same as the number of beams in the beam codebook or beam codebook subset configured by the network entity 104 The IE 102 may report “I” for bit x indicating the beam x in the beam codebook or beam codebook subset is selected, and report “0” for bit y indicating the beam y in the beam codebook or beam codebook subset is not selected.

In some implementations, the IE 102 reports 436 the predicted beam index(es) and absolute RSRP/SINR in an order based on the predicted beam accuracy or predicted RSRP. Table 3 illustrates an example for the UE report, where the predicted beam accuracy or predicted RSRP for the reported beams is in the order of BMI1>BMI2> . . . >BMI N.

TABLE 3
An example for report format for N reported
predicted beams and absolute RSRP/SINR

BMI 1
BMI 2
. . .
BMI N
Predicted RSRP for BMI 1, if reported
Predicted RSRP for BMI 2, if reported
. . .
Predicted RSRP for BMI N, if reported
Predicted SINR for BMI 1, if reported
Predicted SINR for BMI 2, if reported
. . .
Predicted SINR for BMI N, if reported

In some examples, the UE 102 reports 436 the predicted beam index(es) and absolute RSRP/SINR for the best beam and differential RSRP/SINR for other beams. The UE calculates the differential RSRP/SINR with the absolute RSRP/SINR for the best beam as the reference. Table 4 illustrates an example for the BMI and RSRP/SINR report based on differential RSRP/SINR.

TABLE 4
An example for report format for N reported
predicted beams and differential RSRP/SINR

BMI 1
BMI 2
. . .
BMI N
Absolute predicted RSRP for BMI 1, if reported
Differential predicted RSRP for BMI 2, if reported
. . .
Differential predicted RSRP for BMI N, if reported
Absolute predicted SINR for BMI 1, if reported
Differential predicted SINR for BMI 2, if reported
. . .
Differential predicted SINR for BMI N, if reported

In some examples, the UE 102 reports 436 the predicted beam index(es) and absolute RSRP/SINR for the best beam—the beam with highest possibility to be the best beam. Table 5 illustrates an example for the BMI and 1 RSRP/SINR report.

TABLE 5
An example for report format for N reported
predicted beams and 1 RSRP/SINR

BMI 1
BMI 2
. . .
BMI N
Absolute predicted RSRP for BMI 1, if reported
Absolute predicted SINR for BMI 1, if reported

In some cases, the UE 102 reports 436 a second set of predicted beam index(es) to the network entity by indicating a set of BMIs and reports the beam prediction accuracy for the reported predicted beams. The UE 102 determines the prediction accuracy for a beam based on the predicted possibility for the beam to be the best beam. In some implementations, the number of predicted beams in the second set is configured by the network entity by RRC signaling. In some examples, the number of predicted beams in the second set is reported by the UE 102. The UE 102 may determine the number of predicted beams based on the predicted beam accuracy and the first threshold for predicted beam accuracy, and/or the predicted L1-RSRP/L1-SINR and the second threshold for the predicted L1-RSRP/L1-SINR. The UE only reports the beams with the predicted beam accuracy or predicted L1-RSRP/L1-SINR satisfying the report criteria, e.g., exceeding the first/second threshold.

In one example, the UE 102 reports 436 the number of predicted beams in CSI part 1 and reports the set of BMIs in CSI part 2, where the payload size for the set of BMIs in CSI part 2 is based on the reported number of beams in CSI part 1. In another example, the UE reports the number of predicted beams and the set of BMIs in the same CSI part, e.g., CSI part 1 or CSI part 2. The UE 102 may report a bitmap indicating the number of predicted beams and the set of BMIs. The length of the bitmap is the same as the number of beams in the beam codebook or beam codebook subset configured by the network entity 104. The UE 102 may report “1” for bit x indicating the beam x in the beam codebook or beam codebook subset is selected, and report “0” for bit y indicating the beam y in the beam codebook or beam codebook subset is not selected. Table 6 illustrates an example for the BMI and beam prediction accuracy report.

TABLE 6
An example for report format for N reported
predicted beams and prediction accuracy

BMI 1
BMI 2
. . .
BMI N
Predict accuracy for BMI 1
Predict accuracy for BMI 2
. . .
Predict accuracy for BMI N

In some cases, the UE 102 reports 436 a second set of predicted beam index(es) to the network entity by indicating a set of BMIs and reports the beam prediction accuracy and RSRP/SINR for the reported predicted beams. The UE 102 determines the prediction accuracy for a beam based on the predicted possibility for the beam to be the best beam. In some implementations, the number of predicted beams in the second set is configured by the network entity by RRC signaling.

In some examples, the IE 102 reports 436 the number of predicted beams in the second set. The UE may determine the number of predicted beams based on the predicted beam accuracy and the first threshold for predicted beam accuracy, and/or the predicted L1-RSRP/L1-SINR and the second threshold for the predicted L1-RSRP/L1-SINR. The UE only reports the beams with the predicted beam accuracy or predicted L1-RSRP/L1-SINR satisfying the report criteria, e.g., exceeding the first/second threshold.

In one example, the UE reports the number of predicted beams in CSI part 1 and reports the set of BMIs in CSI part 2, where the payload size for the set of BMIs in CSI part 2 is based on the reported number of beams in CSI part 1. In another example, the UE reports the number of predicted beams and the set of BMIs in the same CSI part, e.g., CSI part 1 or CSI part 2. The UE 102 may report a bitmap indicating the number of predicted beams and the set of BMIs. The length of the bitmap is the same as the number of beams in the beam codebook or beam codebook subset configured by the network entity 104. The UE 102 may report “1” for bit x indicating the beam x in the beam codebook or beam codebook subset is selected, and report “0” for bit y indicating the beam y in the beam codebook or beam codebook subset is not selected. Table 7 illustrates an example for the BMI, beam prediction accuracy, and absolute RSRP/SINR report.

TABLE 7
An example for report format for N reported predicted
beams, absolute RSRP/SINR, and beam prediction accuracy

BMI 1
BMI 2
. . .
BMI N
Predicted RSRP for BMI 1, if reported
Predicted RSRP for BMI 2, if reported
. . .
Predicted RSRP for BMI N, if reported
Predicted SINR for BMI 1, if reported
Predicted SINR for BMI 2, if reported
. . .
Predicted SINR for BMI N, if reported
Predict accuracy for BMI 1
Predict accuracy for BMI 2
. . .
Predict accuracy for BMI N

Table 8 illustrates an example for the BMI, beam prediction accuracy and differential RSRP/SINR report.

TABLE 8
An example for report format for N reported predicted beams,
differential RSRP/SINR, and beam prediction accuracy

BMI 1
BMI 2
. . .
BMI N
Absolute predicted RSRP for BMI 1, if reported
Differential predicted RSRP for BMI 2, if reported
. . .
Differential predicted RSRP for BMI N, if reported
Absolute predicted SINR for BMI 1, if reported
Differential predicted SINR for BMI 2, if reported
. . .
Differential predicted SINR for BMI N, if reported
Predict accuracy for BMI 1
Predict accuracy for BMI 2
. . .
Predict accuracy for BMI N

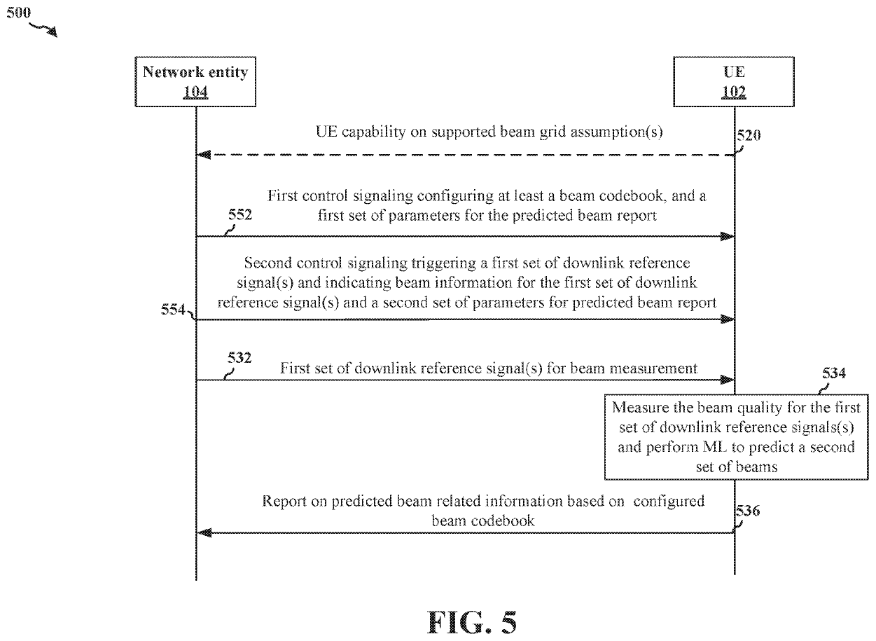

FIG. 5 illustrates a signaling diagram 500 for signaling between the net-work entity 104 and the UE 102 for beam-codebook based beam prediction, in accordance with aspects of the present disclosure. FIG. 5 varies from FIG. 4 in that, alternatively, the network entity transmits 554 the second control signaling indicating the beam information for the first set of downlink reference signals. The second control signaling indicates to the UE 102 that the downlink reference signals will follow (the second signaling). Other signaling aspects are similar to those in FIG. 4.

For example, the UE 102 reports 520 one or more capabilities on the supported beam grid assumptions to the network entity. The network entity 104 transmits 552 the first control signaling to the UE 102. The network entity then transmits 554 the second control signaling triggering a first set of downlink reference signals and indicating beam information for the first set of downlink reference signals and a second set of parameters for the predicted beam report. The network entity transmits 532 the first set of downlink reference signals to the UE 102 for beam measurement. The UE measures 534 the first set of downlink reference signal(s) and performs the ML based beam prediction with the measured beam quality from the first set of downlink reference signal(s) as input. Then the UE transmits 536 predicted beam report to the network, which at least indicates the predicted beam information based on the configured beam codebook.

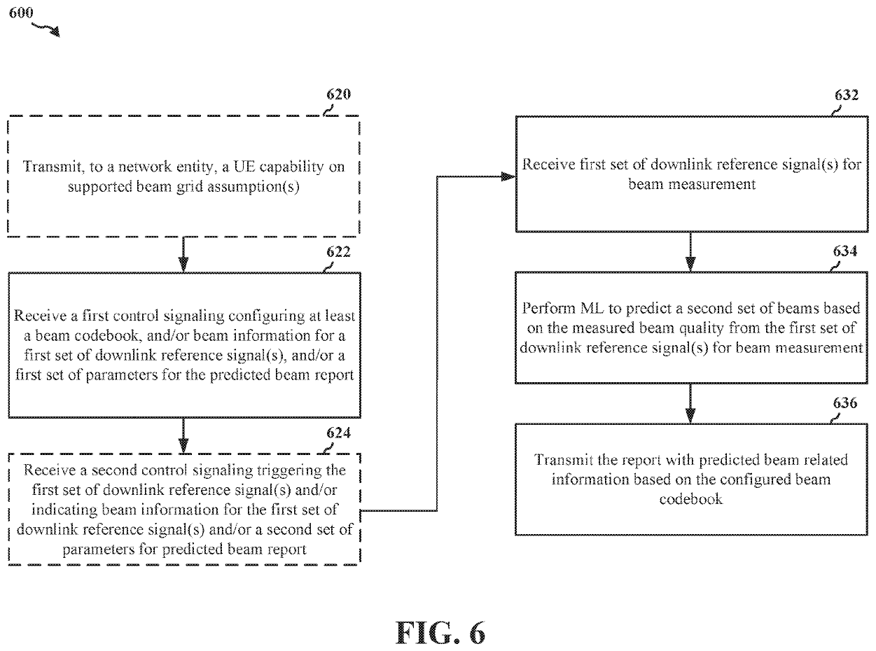

FIG. 6 is a flowchart 600 of a method of wireless communication corresponding to the signaling diagram 400 of FIG. 4 at the UE 102. The flow chart 600 illustrates the UE 102's behavior on network-selected beam codebook based beam prediction. As shown, the UE 102 optionally transmits 620 a UE ability on supported beam grid assumptions. The UE 102 receives 622 a first control signaling configuring at least a beam codebook. In some cases, the first control signaling includes beam information for a first set of downlink reference signals. In some cases, the first control signaling includes a first set of parameters for the predicted beam report.

The UE 102 optionally receives 624 a second control signaling triggering the first set of downlink references signals (transmitted by the network entity 104). The UE 102 receives 632 the first set of downlink reference signals for beam measurement. For example, the first set of downlink reference signals are carried on a subset of multiple beams transmitted from the network entity 104. The UE 102 then performs 634 machine learning (e.g., applying a trained machine learning model) to predict a second set of beams based on the measured beam quality from the first set of downlink reference signals for beam measurement (see, e.g., FIGS. 2-3 for spatial and time domains beam predictions). The UE 102 transmits 636 the predicted beam report with predicted beam related information based on the configured beam codebook.

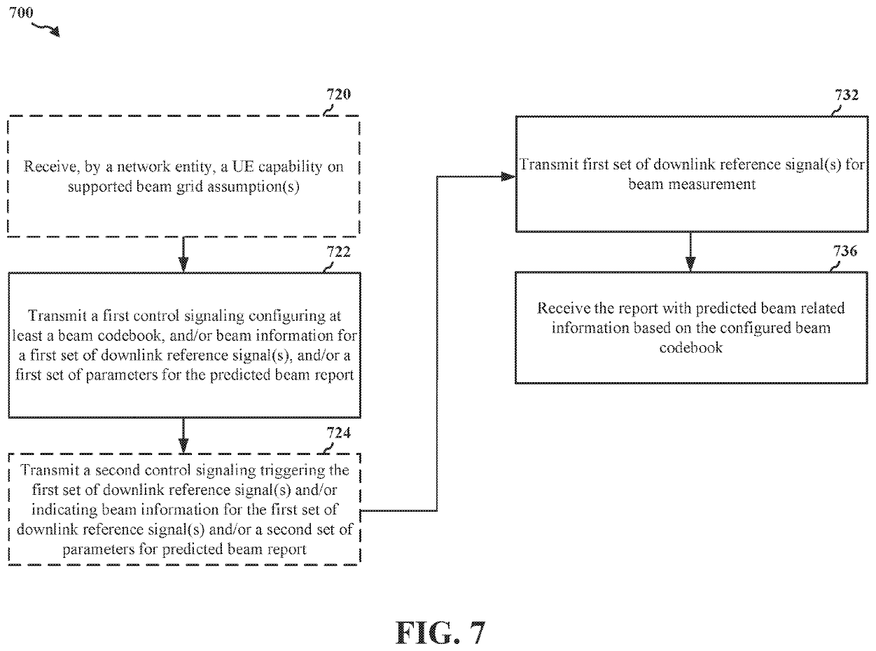

FIG. 7 is a flowchart 700 of a method of wireless communication corresponding to the signaling diagram 400 of FIG. 4 at the network entity 104. The flow chart 700 corresponds to the flow chart 600 and illustrates the network entity 104's behavior on network-selected beam codebook based beam prediction. As shown, the network entity 104 optionally receives 720 a UE ability on supported beam grid assumptions. The network entity 104 transmits 722 a first control signaling configuring at least a beam codebook to the UE 102. The network entity 104 optionally transmits 724 a second control signaling triggering the first set of downlink references signals (transmitted by the network entity 104). The network entity 104 transmits 732 the first set of downlink reference signals for beam measurement. The network entity 104 receives 736 the predicted beam report with predicted beam related information based on the configured beam codebook.

In the present disclosure, an RRC signaling may indicate an RRC reconfiguration message from network entity to UE, or a system information block (SIB), where the SIB can be an existing SIB (e.g., SIB1) or a new SIB (e.g., SIB J, where J is an integer above 21) transmitted by network entity.

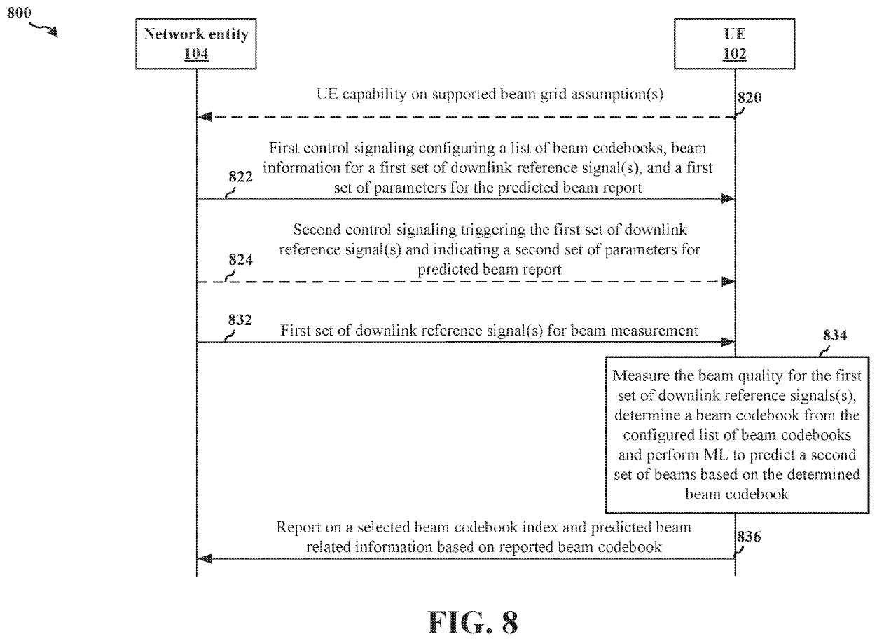

FIG. 8 illustrates a signaling diagram 800 for signaling between a network entity and a UE device for beam-codebook based beam prediction, in accordance with aspects of the present disclosure. The signaling diagram 800 illustrated an example of IE-reported beam codebook for beam codebook based beam prediction. As shown, the UE 102 optionally transmits 820 the UE capability on supported beam grid assumptions. The network entity 104 transmits 822 a first control signaling configuring a list of beam codebooks to the UE 102, along with beam information for a first set of downlink reference signals, and a first set of parameters for the predicted beam report. The network entity 104 may transmit 824 a second control signaling triggering the first set of downlink reference signals and indicating a second setoff parameters for the predicted beam report.

The network entity 104 transmits 832 the first set of downlink reference signals to the UE 102 for beam measurement. The UE 102 measures 834 the beam quality for the first set of downlink reference signals, determines a beam codebook from the configured list of beam codebooks, and performs ML model beam prediction to predict a second set of beams based on the determined beam codebook. The UE 102 reports 836 on the selected beam codebook index, along with predicted beam related information (e.g., predicted beams) based on the selected beam codebook.

The signaling diagram 800 differs from the signaling diagram 400 of FIG. 4 in the following aspects. When the network entity 104 transmits 822 the first control signaling to the UE 102, the network entity may configure a list of beam codebooks based on the UE capability signaling (e.g., received via message 820). In one example, the UE 102 may report 820 a set of supported beam codebooks based on different antenna architectures. The network entity may select the beam codebooks that are aligned with its antenna architecture. The network entity may indicate the beam information for the first set of beam indication based on a default beam codebook, e.g., the first beam codebook configured in the beam codebook list or an indicated beam codebook configured by the network entity from the configured beam codebook list.

After receiving the beam measurement results from the first set of downlink reference signals for beam measurement, the IE 102 may determine abeam codebook and perform the ML-based beam prediction based on the determined beam codebook and the measured beam quality from the received first set of downlink reference signals for beam measurement. Alternatively, the UE 102 may perform multiple ML-based beam prediction procedures based on the configured list of beam codebook and select the one with the best beam prediction accuracy or predicted beam quality, e.g., L1-RSRP or L1-SINR, to report. In the predicted beam report, the UE reports 836 the selected beam codebook index in additional to the predicted beam information (as in the signaling diagram 400).

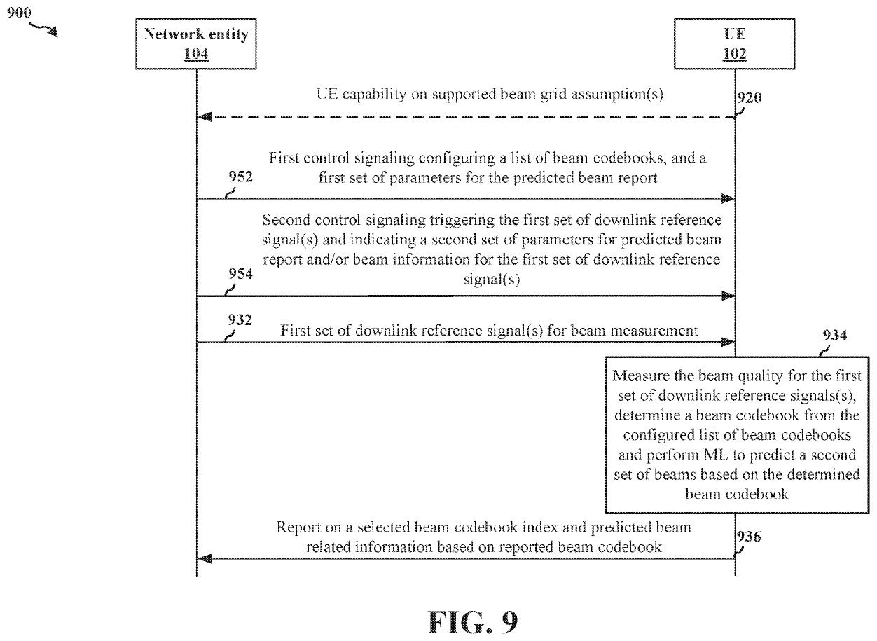

FIG. 9 illustrates a signaling diagram 900 for signaling between a network entity and a UE device for beam-codebook based beam prediction, in accordance with aspects of the present disclosure. The signaling diagram 900 provides an alternative procedure to the signaling diagram 800 regarding the UE-reported beam codebook based beam prediction. The signaling diagram 900 differs from the signaling diagram 800 in that the network entity 104 transmits 952 the first control signaling that configures a list of beam codebooks and a first set of parameters for the predicted beam report (without beam information for the downlink reference signals) and transmits 954, in the second control signaling, the beam information related indication based on a default or indicated beam codebook. The network entity may transmit 954 the second control signaling by MAC CE or DCI. The operations of 920, 932, 934, and 936 are similar to those of 820, 832, 834, and 836, respectively.

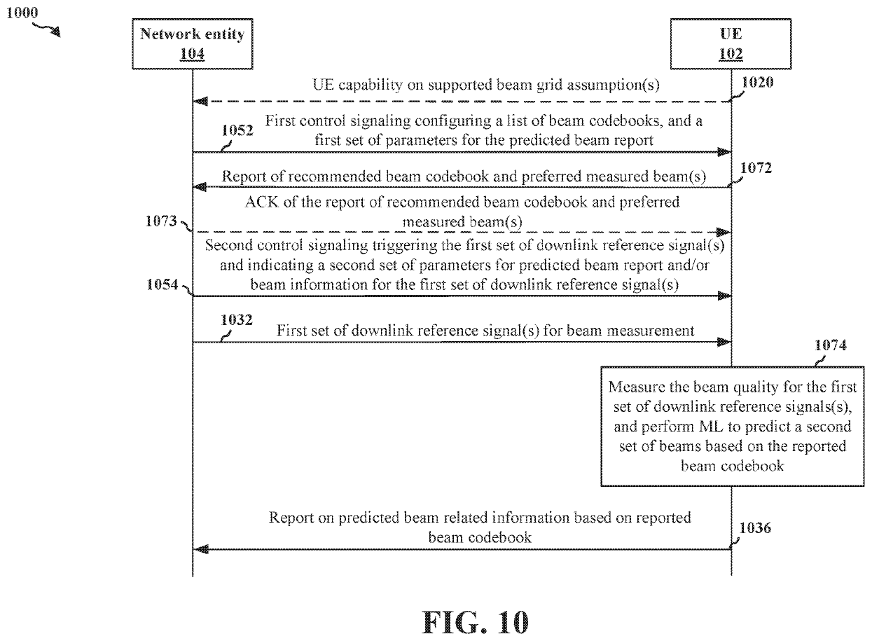

FIG. 10 illustrates a signaling diagram 1000 for signaling between a network entity and a UE device for beam-codebook based beam prediction, in accordance with aspects of the present disclosure. The signaling diagram 1000 provides an alternative procedure to the signaling diagrams 800 and 900 regarding the UE-reported beam codebook based beam prediction. The signaling diagram 1000 differs in that the UE 102 reports 1072 the preferred beam codebook and preferred measured beam(s) (e.g., by RRC signaling, or MAC CE, or DCI), after receiving 1052 the first control signaling.

In some implementations, the network entity 104 may transmit 1073 an acknowledgement of the UE report 1072 on preferred beam codebook and preferred measured beam(s). In some examples, the network entity 104 may directly transmit 1054 the second control signaling triggering the beam report, which may be an implicit way for the acknowledgement of the UE report (that is, without the acknowledgement 1073). The UE 102 performs 1074 ML beam predictions based on the reported beam codebook (the recommended beam codebook reported at 1072). In the predicted beam report, the UE reports the predicted beam information based on the reported beam codebook. The operations of 1020, 1052, 1054, 1032, and 1036 are similar to those of 920, 952, 954, 932, and 936, respectively.

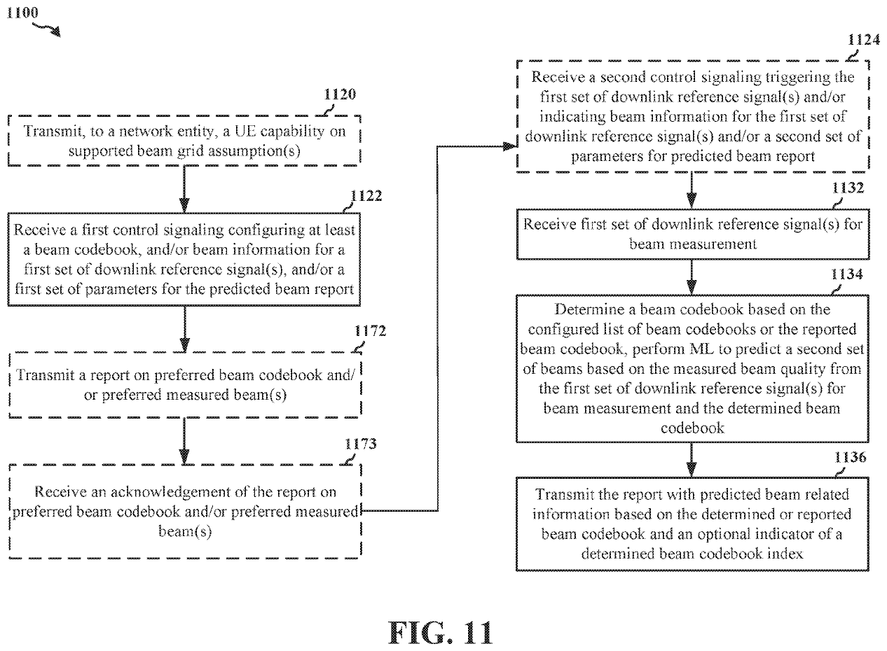

FIG. 11 is a flowchart 1100 of a method of wireless communication corresponding to the signaling diagram 1000 of FIG. 10 at the UE 102. As shown, the UE 102 optionally transmits 1120 to the network entity 104 a UE capability on supported beam grid parameters. The UE 102 receives 1122 a first control signaling configuring at least a beam codebook. The first control signaling may also include beam information for a first set of downlink reference signals, and/or a first set of parameters for the predicted beam report. The UE 102 optionally transmits 1172 a report on a preferred beam codebook and/or one or more preferred measured beams.

The UE 102 receives 1173 an acknowledgement of the report sent at 1172. The UE 102 optionally receives 1124 a second control signaling triggering the first set of downlink reference signals, or indicating beam information for the first set of downlink reference signals, a second set of parameters for the predicted beam report, or any combination of the above.

The UE 102 receives 1132 the first set of downlink reference signals for beam measurement. The UE 102 determines 1134 a beam codebook based on the configured list of beam codebooks or the reported beam codebook, and performs ML to predict a second set of beams based on the measured beam quality from the first set of downlink reference signals for beam measurement and the determined beam codebook.

The UE 102 transmits 1136 the report with predicted beam related information based on the determined or the reported beam codebook and an optional indicator of a determined beam codebook index (identifying one of the list of beam codebooks configured by the network entity 104).

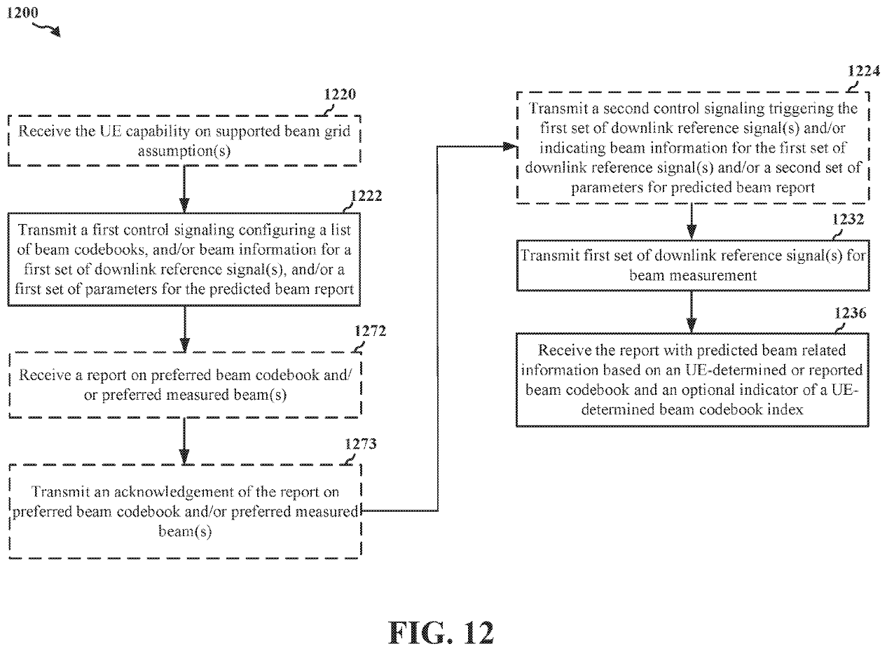

FIG. 12 is a flowchart 1200 of a method of wireless communication corresponding to the signaling diagram 1000 of FIG. 10 at the network entity 104. The flowchart 1200 is complementary to the flow chart 1300. As shown, the network entity 104 optionally receives 1220 the UE capability on supported beam grid assumptions. The network entity 104 transmits 1222 a first control signaling configuring, at least a beam codebook. The first control signaling may also include beam information for a first set of downlink reference signals, and/or a first set of parameters for the predicted beam report. The network entity 104 receives (optionally) 1272 the report on a preferred beam codebook and/or one or more preferred measured beams. In response to the received report, the network entity 102 transmits 1273 an acknowledgement of the report received at 1272.

The network entity 104 optionally transmits 1224 a second control signaling triggering the first set of downlink reference signals, or indicating beam information for the first set of downlink reference signals, a second set of parameters for the predicted beam report, or any combination of the above. The network entity 104 transmits 1232 the first set of downlink reference signals for beam measurement at the UE 102. The network entity 104 receives 1236 the report with predicted beam related information based on the determined or the reported beam codebook and an optional indicator of a determined beam codebook index.

When the UE reports a preferred beam codebook, as in the examples of FIGS. 8-12, the first control signaling may implement one or more of the examples below.

In an example, compared to the embodiment for the first/second control signaling for network-configured beam codebook based beam prediction in FIG. 4, the difference on the first/second control signaling for the procedure in FIGS. 8-10 is that the network entity 104 configures a list of beam codebooks (and allows the UE 102 to choose). In each codebook, the network entity configures the beam grid and antenna architecture related parameters.

In one example, the network entity 104 may configure the beam codebook list in a. CSI-ReportConfig by beamCodebookConfigList as follows.

### Configuration Example

| CSI-ReportConfig ::= | SEQUENCE { | |
|---|---|---|
| reportConfigId | CSI-ReportConfigId, | |
| carrier | ServCellIndex OPTIONAL, -- Need S | |
| resourcesForChannelMeasurement | CSI-ResourceConfigId, | |
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |

| | |
|---|---|
| reportConfigType | CHOICE { |
| periodic | SEQUENCE { |
| resportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) OF PUCCH-CSI- |

Resource
},

| | |
|---|---|
| semiPersistentOnPUSCH | SEQUENCE { |
| reportSlotConfig | ENUMERATED {s15, s110, s120, s140, s180, s1160, |

s1320},

| | |
|---|---|
| reportSlotOffsetList | SEQUENCE (SIZE (1.. maxNrofUL-Allocations)) OF |

INTEGER(0..32),

| | |
|---|---|
| p0alpha | P0-PUSCH-AlphaSetId |

},

| | |
|---|---|
| aperiodic | SEQUENCE { |
| reportSlotOffsetList | SEQUENCE (SIZE (1..maxNrofUL-Allocations)) OF |

```
INTEGER(0..32)
    }
  },
```

| reportQuantity | CHOICE { | |
|---|---|---|
| none | NULL, | |
| cri-RI-PMI-CQI | NULL, | |
| cri-RI-i1 | NULL, | |
| cri-RI-i1-CQI | SEQUENCE { | |
| pdsch-BundleSizeForCSI | ENUMERATED {n2, n4} | OPTIONAL - |

- Need S
},

| | |
|---|---|
| cri-RI-CQI | NULL, |
| cri-RSRP | NULL, |
| ssb-Index-RSRP | NULL, |
| cri-RI-LI-PMI-CQI | NULL, |
| bmi | NULL, |
| bmi-RSRP | NULL, |
| bmi-SINR | NULL, |
| bmi-RSRP-SINR | NULL, |
| bmi-accuracy | NULL, |
| bmi-RSRP-accuracy | NULL, |
| bmi-SINR-accuracy | NULL, |
| bmi-RSRP-SINR-accuracy | NULL, |

```
    },
    <unrelated part omitted>
```

| | |
|---|---|
| beamCodebookConfigList | SEQUENCE (SIZE (1..maxNrofBeamCodebooks)) OF |
| BeamCodebookConfig | OPTIONAL, -- Need R |

}
maxNrofBeamCodebooks INTEGER ::= 8

| | |
|---|---|
| BeamCodebookConfig ::= | SEQUENCE { |
| antennaConfig | SEQUENCE { |
| n1-n2 | CHOICE { |
| four-four | BIT STRING (SIZE (16)), |
| eight-four | BIT STRING (SIZE (16)), |
| eight-eight | BIT STRING (SIZE (16)), |
| sixteen-four | BIT STRING (SIZE (8)), |
| sixteen-eight | BIT STRING (SIZE (8)), |

},

| | |
|---|---|
| beamCodebookRestriction | BIT STRING (SIZE (256)) |

}

| | |
|---|---|
| beamCodebookMode | INTEGER (1..2) |

}

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |

nzp-CSI-RS-ResourceSetList SEQUENCE (SIZE (1..maxNrofNZP-CSI-RS-
ResourceSetsPerConfig)) OF NZP-CSI-RS-ResourceSetId

OPTIONAL, -- Need R

| | |
|---|---|
| csi-SSB-ResourceSetList | SEQUENCE (SIZE (1..maxNrofCSI-SSB- |

ResourceSetsPerConfig)) OF CSI-SSB-ResourceSetId OPTIONAL -- Need R

| | |
|---|---|
| bmiListCsiRs | SEQUENCE (SIZE (1..maxNrofNZP-CSI-RS-ResourceSetsPerConfig)) |

OF INTEGER (0..255) OPTIONAL -- Need R

| | |
|---|---|
| bmiListSsb | SEQUENCE (SIZE (1..maxNrofCSI-SSB-ResourceSetsPerConfig)) OF |

INTEGER (0..255) OPTIONAL -- Need R
},

| | |
|---|---|
| csi-IM-ResourceSetList | SEQUENCE (SIZE (1..maxNrofCSI-IM-ResourceSetsPerConfig)) OF |

CSI-IM-ResourceSetId
},

| | |
|---|---|
| bwp-Id | BWP-Id, |
| resourceType | ENUMERATED { aperiodic, semiPersistent, periodic }, |

```
  ...,
  [[
```

| | |
|---|---|
| csi-SSB-ResourceSetListExt-r17 | CSI-SSB-ResourceSetId |

OPTIONAL -- Need R
]]
}

In some examples, the network entity 104 may transmit the second control signaling indicating the beam information for the first set of downlink reference signals for beam measurement. The network entity 104 may transmit the second control signaling by MAC CE or DCI. The network entity 104 may indicate the beam information by BMIs based on the UE reported beam codebook or a default beam codebook or an network entity indicated beam codebook.

When the UE 102 reports 1072 recommended beam codebook to the network entity 104, the UE 102 may report the preferred beam codebook and/or preferred measured beams by RRC signaling. Before UE reports the preferred beam codebook, a default beam codebook, e.g., the first beam codebook configured in the list of beam codebooks configured in the first control signaling, is applied for beam prediction. For the RRC based beam codebook report, the network entity transmits the acknowledgement (ACK) of the RRC based on legacy approach for a normal RRC based report.

In some implementations, the UE 102 may report the preferred beam codebook index and/or preferred measured beams based on the reported preferred beam codebook by RRC signaling, e.g., UEAssistanceInformation. In one example, the UE may report the preferred beam codebook index by preferredBeamCodebookIndex, and report the preferred measured beams by preferredMeasuredBeams, which indicates the BMI based on the reported beam codebook.

### Report Example

UEAssistanceInformation-vxxxx-IEs ::= SEQUENCE {

| | |
|---|---|
| preferredBeamCodebookIndex | INTEGER(1..maxNrofBeamCodebooks) OPTIONAL, |
| preferredMeasuredBeams | SEQUENCE(SIZE (1..maxNrofMeasuredBeams) OF |

INTEGER(1..maxNrofBeamsInBeamCodebook)) OPTIONAL,
}
maxNrofBeamCodebooks INTEGER ::= 8
maxNrofMeasuredBeams INTEGER ::= 16
maxNrofBeamsInBeamCodebook INTEGER ::= 256

In some examples, the UE may report the preferred beam codebook configuration and/or preferred measured beams based on the reported preferred beam codebook by RRC signaling, e.g., UEAssistanceInfornmtion. In one example, the UE may report the preferred beam codebook configuration by preferredBeamCodebookConfig, and report the preferred measured beams by preferredMeasuredBeams, which indicates the BMI based on the reported beam codebook. Report Example

UEAssistanceInformation-vxxxx-IEs ::= SEQUENCE {

| | |
|---|---|
| preferredBeamCodebookConfig | BeamCodebookConfig OPTIONAL, |
| preferredMeasuredBeams | SEQUENCE(SIZE (1..maxNrofMeasuredBeams) OF |

INTEGER(1..maxNrofBeamsInBeamCodebook)) OPTIONAL,
}
maxNrofMeasuredBeams INTEGER ::= 16
maxNrofBeamsInBeamCodebook INTEGER ::= 256

When the UE 102 reports 1072 recommended beam codebook to the network entity 104, the UE 102 may report the preferred beam codebook and/or preferred measured beams by MAC CE. The UE applies the preferred beam codebook for further communication after X slots after UE receives the ACK for the MAC CE, where X may be predefined, e.g., 2 slots, or reported by the UE via UE capability or configured by the network entity by RRC signaling.

Before UE applies the reported preferred beam codebook, a default beam codebook, e.g., the first beam codebook configured in the list of beam codebooks configured in the first control signaling, is applied for beam prediction. In some implementations, the network entity 104 transmits the ACK for the MAC CE by a PDCCH scheduling a new transmission in the same HARQ process as that used for the MAC CE report. In some examples, the network entity 104 transmits the ACK for the MAC CE by a PDCCH in a dedicated search space or control resource set, which may be predefined or configured by RRC signaling by the network entity. In some examples, the network entity 104 transmits the ACK for the MAC CE by a PDCCH with a dedicated cell radio network temporary identifier (RNTI), which may be predefined or configured by RRC signaling by the network entity.

In some implementations, the MAC CE may include one or more of the following elements: a serving cell index or serving cell group index indicating the serving cell or serving cell group to apply the preferred beam codebook, a bandwidth part index indicating the bandwidth part for the serving cell or serving cell group to apply the preferred beam codebook, a preferred beam codebook index indicating the beam codebook index selected from the list of beam codebooks configured by the first control signaling, a preferred measured beams indicating the BMIs for the preferred measured beams selected from the preferred beam codebook index, and a preferred number of preferred measured beams indicating the preferred number of preferred measured beams for ML-based beam prediction.

When the UE 102 reports 1072 recommended beam codebook to the network entity 104, the UE 102 may report the preferred/selected beam codebook and/or preferred measured beams by an uplink control information (UCI) report. The UE transmits the UCI by PUCCH or PUSCH.

In some implementations, the UE 102 transmits the preferred beam codebook and/or preferred measured beams by a UCI The dedicated UCI may include at least one of the elements: preferred beam codebook index; preferred measured beams; preferred number of measured beams. The UE applies the preferred beam codebook for further communication after X slots after UE receives the ACK for the UCI, where X may be predefined, e.g., 2 slots, or reported by the UE via UE capability or configured by the network entity by RRC signaling. Before UE applies the reported preferred beam codebook, a default beam codebook, e.g., the first beam codebook configured in the list of beam codebooks configured in the first control signaling, is applied for beam prediction.

In some implementations, the network entity 104 transmits the ACK for the MAC CE by a PDCCH in a dedicated search space or control resource set, which may be predefined or configured by RRC signaling by the network entity. In some examples, the network entity transmits the ACK for the MAC CE by a PDCCH with a dedicated cell radio network temporary identifier (RNTI), which may be predefined or configured by RRC signaling by the network entity.

In some examples, the UE 102 transmits the selected beam codebook index and the predicted beam information by a UCI. The UE may transmit the selected beam codebook and the predicted beam information in the same CSI part. Alternatively, the UE may transmit the selected beam codebook index in CST part 1 and the predicted beam information CSI part 2, where the payload size for the predicted beam indication is based on the reported selected beam codebook. Alternatively, the UE may transmit the selected beam codebook index and number of predicted beams in CSI part 1, and transmit the predicted beam index, e.g., BMI and other information for the predicted beam in CSI part 2.

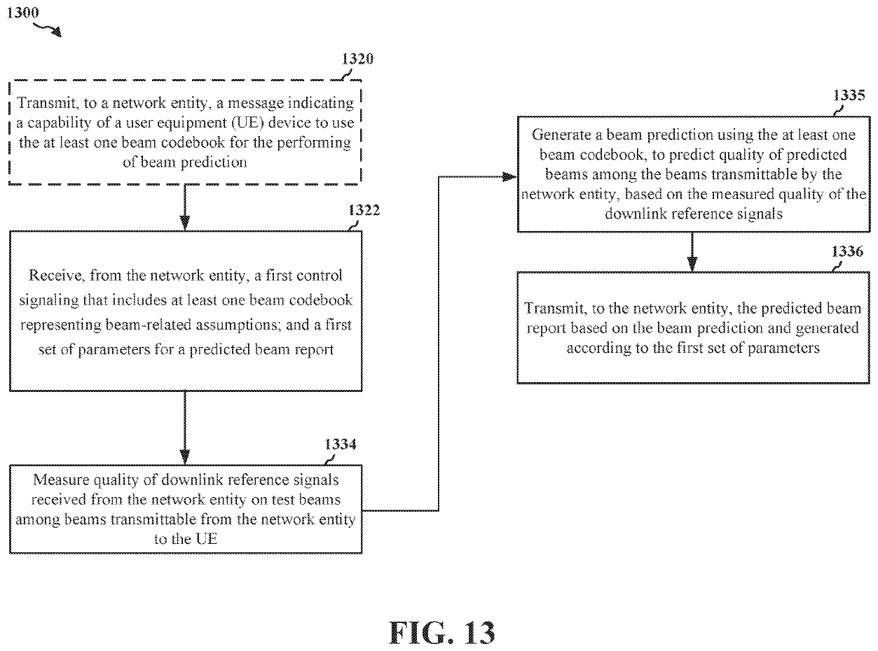

FIG. 13 illustrates a flowchart 1300 of a method of wireless communication at a UE (such as the UE 102). With reference to FIGS. 1-12, and 15, the method may be performed by the UE 102, the UE device 1502, etc., which may include the memory 1526′, 1506′ 1516, and which may correspond to the entire UE 102 or the entire UE device 1502, or a component of the UE 102 or the UE device 1502, such as the wireless baseband processor 1526 and/or the application processor 1506.

As shown in the flowchart 1300, the UE 102 optionally transmits 1320, to a network entity, a message indicating a capability of the UE 102 to use at least one beam codebook for the performing of beam prediction. For example, referring to FIGS. 4-12, the UE 102 transmits (e.g., 420), to the network entity 104, a UE capability report for the UE 102 to use at least one beam codebook (e.g., supported beam grid assumptions) to perform ML beam prediction.

The UE 102 receives 1322, from the network entity, a first control signaling that includes at least one beam codebook representing beam-related assumptions; and a first set of parameters for a predicted beam report. For example, referring to FIGS. 4-12, the UE 102 receives (e.g., 422), from the network entity 104, first control signaling that configures at least a beam codebook (see FIGS. 4-7) or a list of beam codebooks for the UE to select (see FIGS. 8-12).

The UE 102 measures 1334 quality of downlink reference signals received from the network entity on test beams among beams transmittable from the network entity to the UE.

The UE 102 generates 1335 a beam prediction using the at least one beam codebook, to predict quality of predicted beams among the beams transmittable by the network entity, based on the measured quality of the downlink reference signals. For example, referring to FIGS. 4-12, the UE 102 measures (e.g., 434) downlink references signals and use a network configured beam codebook or a UE reported beam codebook to perform beam prediction to generate the predicted beam report. For example, the beam prediction may use a machine learning model to predict multiple beams (not measured) in the beam grid transmittable by the network entity 104 (see FIGS. 2-3).

The UE 102 transmits 1336, to the network entity, the predicted beam report based on the beam prediction.

In some aspects, the at least one beam codebook includes codebook parameters for calculating antenna phase offsets, the codebook parameters including one or more of: a horizontal angle of span of a beam grid transmittable by the network entity via an antenna device; a vertical angle of span of the beam grid; a number of horizontal beams of the beam grid of the antenna; a number of vertical beams of the beam grid; a vertical and horizontal angle for each beam; a number of horizontal antenna ports; a number of vertical antenna ports; an antenna spacing in a vertical space domain; or an antenna spacing in a horizontal space domain.

In some aspects, the at least one beam codebook includes codebook parameters for calculating digital Fourier transform vectors characterizing beams, the codebook parameters including one or more of: an oversampling factor in the horizontal space domain; an oversampling factor in the vertical space domain; a number of horizontal antenna ports; and a number of vertical antenna ports.

In some aspects, the UE 102 transmits, to the network entity, a message indicating a capability of the U E device to use the at least one beam codebook for generating the beam prediction. In some cases, the message indicating the capability of the UE device to use the at least one beam codebook for the beam prediction performed by the UE device includes one or more of: a minimum number of downlink reference signals needed for beam prediction; a maximum number of downlink reference signals applicable for beam prediction; a maximum number of downlink reference signals in a slot for beam prediction: a minimum number of predicted beams needed to identify the best beam; a maximum number of predicted beams applicable to identify the best beam; or one or more preferred beams for measurement.

In some aspects, the first control signaling further comprises one or more of: a beam codebook subset restriction indicating a subset of beams to be used for a beam information indication, the predicted beam report, or both; a report quantity indicating a report quantity for predicted beams to be included in the predicted beam report; a beam matrix indicator (BMI) for each beam associated with at least one of the downlink reference signals; a first threshold for limiting a beam prediction accuracy of beams included in the predicted beam report; or a second threshold for limiting a predicted reference signal received power (RSRP) or a predicted signal-to-interference plus noise ratio (SINR) of beams included in the predicted beam report.

In some aspects, performing of the beam prediction, by the UE device using the beam codebook includes generating the beam prediction using a machine learning model; and preparing the predicted beam report indicating one or more predicted beams in the beam prediction having highest predicted RSRP, SINR, or both, the predicted beam report including quality information of the one or more predicted beams identified in either a spatial domain or in a time domain.

In some aspects, the beam prediction report includes: a set of predicted beam indexes ordered based on beam prediction accuracies of one or more reported predicted beams.

In some aspects, the beam prediction report includes: a set of predicted beam indexes ordered based on a predicted reference signal received power (RSRP) of one or more reported predicted beams; or the set of predicted beam indexes ordered based on a predicted signal-to-interference plus noise ratio (SINR) of the one or more reported predicted beams.

In some aspects, the beam prediction report includes: a beam codebook index corresponding to one of the at least one beam codebook; and beam quality information corresponding to the beam prediction obtained using the one of the at least one beam codebook.

In some aspects, the beam prediction report further includes a beam prediction accuracy of at least one beam in the beam prediction.

In some aspects, the beam prediction report further includes an RSRP of at least one beam in the beam prediction.

In some aspects, the beam prediction report further includes: an SINR of at least one beam in the beam prediction.

In some aspects, the at least one beam codebook indicates two or more beam codebooks. The UE 102 selects a preferred beam codebook among the two or more beam codebooks. The UE 102 generates the beam prediction using the preferred beam codebook (e.g., for yielding a best predicted beam quality and/or accuracy). In some cases, the beam prediction report further includes an indication of the preferred beam codebook; and a set of preferred beams among beams in the beam prediction generated using the preferred beam codebook.

In some aspects, the UE 102 transmits the beam prediction report using a radio resource control (RRC) signaling; a medium access control (MAC) control element (CE) signaling; or an uplink control information (UCI) report.

In some aspects, the UE receives, from the network entity, a second control signaling indicating that the network entity initiates sending the downlink reference signals, and including a second set of parameters for the beam prediction report, wherein the beam prediction report is further based on the second set of parameters.

In some cases, the first control signaling is included in a radio resource control (RRC) signaling; and the second control signaling is included in a medium access control (MAC) control element (CE) signaling or a downlink control information (DCI) signaling.

In some aspects, the downlink reference signals include a set of synchronization signal blocks (SSBs) or a set of channel state information (CSI) reference signals (RS).

In some aspects, the first control signaling further includes beam information of the downlink reference signals corresponding to a subset of a grid of beams transmittable by the network entity, wherein measuring quality of downlink reference signals from the network entity is based on the beam information in the first control signaling.

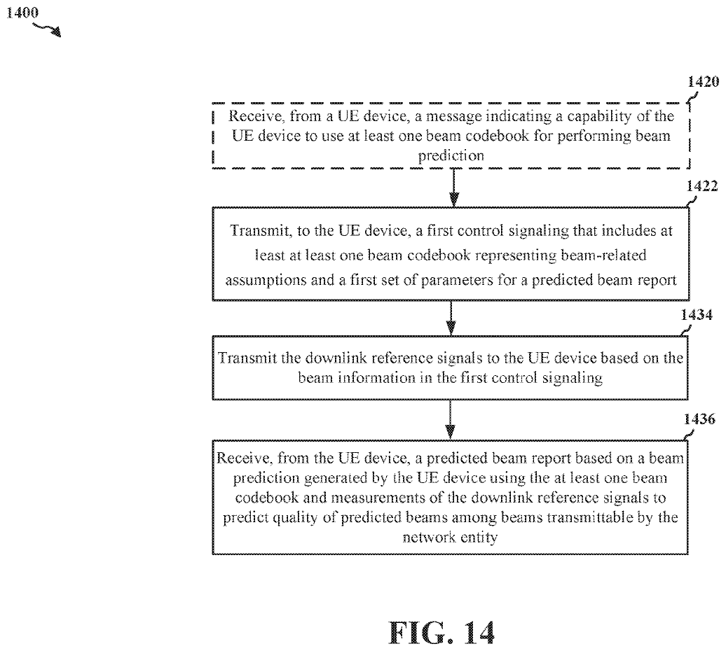

FIG. 14 is a flowchart 1400 of a method of wireless communication at a network entity (such as the network entity 104). With reference to FIGS. 1-12, and 16, the method may be performed by one or more network entities 104, which may correspond to a base station or a unit of the base station, such as the RU 106, the DU 108, the CU 110, an RU processor 1606, a DU processor 1626, a CU processor 1646, etc. The one or more network entities 104 may include memory 160671626/1646′ which may correspond to an entirety of the one or more network entities 104, or a component of the one or more network entities 104, such as the RU processor 1606, the DU processor 1626, or the CU processor 1646. The flowchart 1400 is complementary to the flowchart 1300 in terms of interactive operations between the UE 102 and the network entity 104, which share various aspects as described above.

The network entity 104 receives 1420, from a UE, a message indicating a capability of the UE device to use at least one beam codebook for performing beam prediction. For example, referring to FIGS. 4-12, the network entity 104 receives (e.g. 420), from the UE 102, a message regarding the UE's capability on supported beam grid assumptions. The network entity 104 transmits 1422, to the UE, a first control signaling that includes at least at least one beam codebook representing beam-related assumptions and a first set of parameters for a predicted beam report. The network entity 104 transmits 1434 the downlink reference signals to the UE device based on the beam information in the first control signaling. The network entity receives 1436, from the UE device, a predicted beam report based on a beam prediction generated by the UE device using the at least one beam codebook and measurements of the downlink reference signals to predict quality of predicted beams among beams transmittable by the network entity.

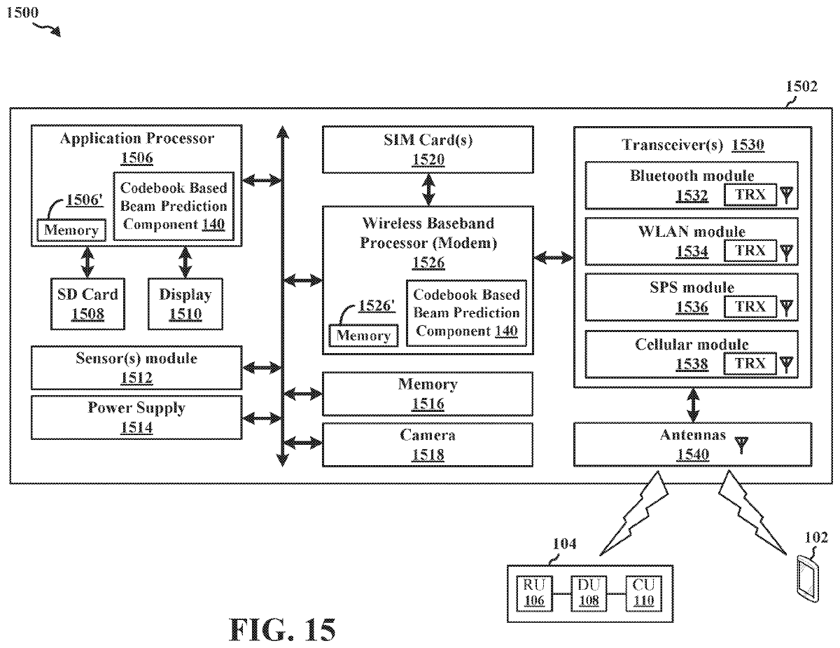

FIG. 15 is a diagram 1500 illustrating an example of a hardware implementation for a UE device 1502. The UE device 1502 may be the UE 102, a component of the UE 102, or may implement UE functionality. The UE device 1502 may include an application processor 1506, which may have on-chip memory 1506′. In examples, the application processor 1506 may be coupled to a secure digital (SD) card 1508 and/or a display 1510. The application processor 1506 may also be coupled to a sensor(s) module 1512, a power supply 1514, an additional module of memory 1516, a camera 1518, and/or other related components. For example, the sensor(s) module 1512 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE device 1502 may further include a wireless baseband processor 1526, which may be referred to as a modem. The wireless baseband processor 1526 may have on-chip memory 1526′. Along with, and similar to, the application processor 1506, the wireless baseband processor 1526 may also be coupled to the sensor(s) module 1512, the power supply 1514, the additional module of memory 1516, the camera 1518, and/or other related components. The wireless baseband processor 1526 may be additionally coupled to one or more subscriber identity module (SIM) card(s) 1520 and/or one or more transceivers 1530 (e.g., wireless RF transceivers).

Within the one or more transceivers 1530, the UE device 1502 may include a Bluetooth module 1532, a WLAN module 1534, an SPS module 1536 (e.g., GNSS module), and/or a cellular module 1538. The Bluetooth module 1532, the WLAN module 1534, the SPS module 1536, and the cellular module 1538 may each include an on-chip transceiver (TRX), or in some cases, just a transmitter (TX) or just a receiver (RX). The Bluetooth module 1532, the WL AN module 1534, the SPS module 1536, and the cellular module 1538 may each include dedicated antennas and/or utilize antennas 1540 for communication with one or more other nodes. For example, the UE device 1502 can communicate through the transceiver(s) 1530 via the antennas 1540 with another UE 102 (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 1526 and the application processor 1506 may each include a computer-readable medium/memory 1526′, 1506′, respectively. The additional module of memory 1516 may also be considered a computer-readable medium/memory. Each computer-readable medium/memory 1526, 1506′, 1516 may be non-transitory. The wireless baseband processor 1526 and the application processor 1506 may each be responsible for general processing, including execution of software stored on the computer-readable medium/memory 1526, 1506′, 1516. The software, when executed by the wireless baseband processor 1526/application processor 1506, causes the wireless baseband processor 1526/application processor 1506 to perform the various functions described herein. The computer-readable medium/memory may also be used for storing data that is manipulated by the wireless baseband processor 1526/application processor 1506 when executing the software. The wireless baseband processor 1526/application processor 1506 may be a component of the UE 102. The UE device 1502 may be a processor chip (e.g., modem and/or application) and include just the wireless baseband processor 1526 and/or the application processor 1506. In other examples, the UE device 1502 may be the entire UE 102 and include the additional modules of the apparatus 1502.

As discussed, the beam codebook based beam prediction component 140 is configured to receive, from a network entity, a first control signaling that includes at least one beam codebook representing beam-related assumptions; and a first set of parameters for a predicted beam report. The beam codebook based beam prediction component 140 measures quality of downlink reference signals from the network entity and generates a beam prediction using the at least one beam codebook, to predict quality of beams transmittable by the network entity, based on the measured quality of the downlink reference signals. The beam codebook based beam prediction component 140 causes the transmitting, to the network entity, the predicted beam report based on the beam prediction and generated according to the first set of parameters.

The beam codebook based beam prediction component 140 may be within the wireless baseband processor 1526, the application processor 1506, or both the wireless baseband processor 1526 and the application processor 1506. The beam codebook based beam prediction component 140 may be one or more hardware components specifically configured to carry out the stated processes/algorithm, implemented by one or more processors configured to perform the stated processes/algorithm, stored within a computer-readable medium for implementation by the one or more processors, or a combination thereof.

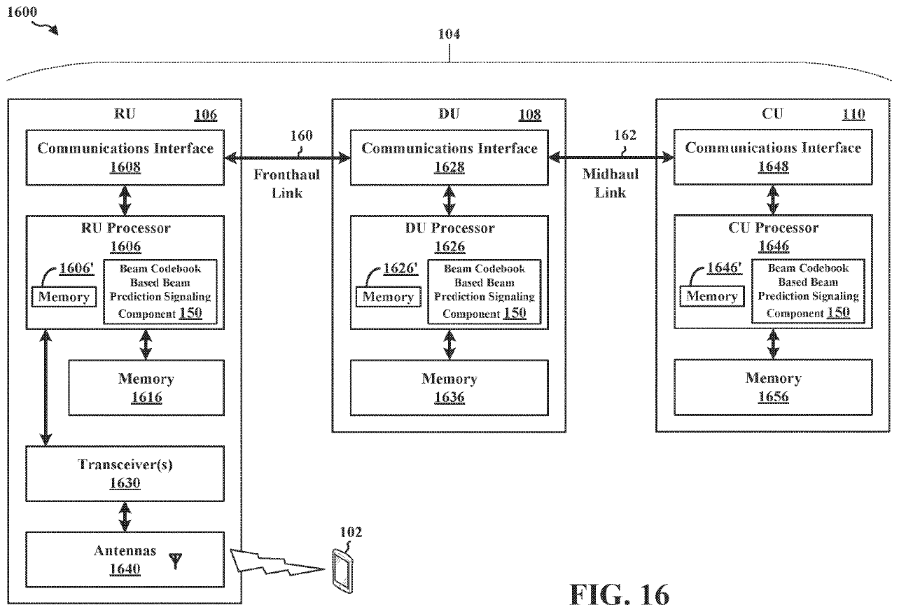

FIG. 16 is a diagram 1600 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 160. The CU 160 may include a CU processor 1646, which may have on-chip memory 1646′. In some aspects, the CU 160 may further include an additional module of memory 1656 and/or a communications interface 1648, both of which may be coupled to the CU processor 1646. The CU 160 can communicate with the DU 108 through a midhaul link 162, such as an F1 interface between the communications interface 1648 of the CU 160 and a communications interface 1628 of the DU 108.

The DU 108 may include a DU processor 1626, which may have on-chip memory 1626. In some aspects, the DU 108 may further include an additional module of memory 1636 and/or the communications interface 1628, both of which may be coupled to the DU processor 1626. The DU 108 can communicate with the RU 106 through a fronthaul link 160 between the communications interface 1628 of the DU 108 and a communications interface 1608 of the RU 106.

The RU 106 may include an RU processor 1606, which may have on-chip memory 1606. In some aspects, the RU 106 may further include an additional module of memory 1616, the communications interface 1608, and one or more transceivers 1630, all of which may be coupled to the RU processor 1606. The RU 106 may further include antennas 1640, which may be coupled to the one or more transceivers 1630, such that the RU 106 can communicate through the one or more transceivers 1630 via the antennas 1640 with the UE 102.

The on-chip memory 1606′, 1626′, 1646′ and the additional modules of memory 1616, 1636, 1656 may each be considered a computer-readable medium/memory. Each computer-readable medium/memory may be non-transitory. Each of the processors 1606, 1626, 1646 is responsible for general processing, including execution of software stored on the computer-readable medium/memory. The software, when executed by the corresponding processor(s) 1606, 1626, 1646 causes the processor(s) 1606, 1626, 1646 to perform the various functions described herein. The computer-readable medium/memory may also be used for storing data that is manipulated by the processor(s) 1606, 1626, 1646 when executing the software. In examples, the beam codebook based beam prediction signaling component 150 may sit at the one or more network entities 104, such as at the CU 160; both the CU 160 and the DU 108: each of the CU 160, the DU 108, and the RU 106; the DLU 108; both the DU 108 and the RU 106; or the RU 106.

As discussed, the beam codebook based beam prediction signaling component 150 is configured to transmit, to a LUE, a first control signaling that includes at least at least one beam codebook representing beam-related assumptions and a first set of parameters for a predicted beam report. The beam codebook based beam prediction signaling component 150 is further configured to transmit (or cause the transmitting of) the downlink reference signals to the LUE device based on the beam information in the first control signaling. The beam codebook based beam prediction signaling component 150 is configured to receive, from the UE device, a predicted beam report based on beam prediction generated by the UE device using the at least one beam codebook to predict quality of beams transmittable by the network entity and based on the measured quality of the downlink reference signals.

The beam codebook based beam prediction signaling component 150 may be within one or more processors of the one or more network entities 104, such as the RU processor 1606, the DU processor 1626, and/or the CU processor 1646. The beam codebook based beam prediction signaling component 150 may be one or more hardware components specifically configured to carry out the stated processes/algorithm, implemented by one or more processors 1606, 1626, 1646 configured to perform the stated processes/algorithm, stored within a computer-readable medium for implementation by the one or more processors 1606, 1626, 1646, or a combination thereof.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

### Example Aspects

### UE Aspect

Example 1. An apparatus, comprising a processer configured to cause a User Equipment (UE) to:
   receive a first control signaling indicating at least one beam codebook for beam prediction and a first set of downlink reference signals for beam prediction;
   receive the first set of downlink reference signals for beam prediction;
   transmit at least a second set of predicted beam index(es) report based on one of the received beam codebooks and the received first set of downlink reference signals.
Example 2. The apparatus according to Example 1, wherein UE transmits UE capability on supported beam codebook assumptions.
Example 3. The apparatus according to Example 2, wherein the UE transmits the UE capability for a beam codebook assumption with at least one of the UE capabilities including horizontal angle span for the beam grid; number of horizontal beams; vertical angle span for the beam grid; number of vertical beams; vertical and horizontal angle for each beam; number of horizontal antenna elements/ports; number of vertical antenna elements/ports; antenna spacing in vertical domain; antenna spacing in horizontal domain.
Example 4. The apparatus according to Example 2, wherein the UE transmits the UE capability for a beam codebook assumption with at least one of the UE capabilities including oversampling factor in horizontal domain; oversampling factor in vertical domain: number of horizontal antenna elements/ports; number of vertical antenna elements/ports.
Example 5. The apparatus according to Example 2, wherein the UE further transmits one or more than one UE capabilities including: the minimal number of downlink reference signals for beam prediction, the maximum number of downlink reference signals for beam prediction, the maximum number of downlink reference signals in a slot for beam prediction, the minimal number of predicted beams to identify the best beam, the maximum number of predicted beams to identify the best beam, and the preferred beams for measurement.
Example 6. The apparatus according to Example 1, wherein the UE receives the first control signaling indicating at least one of the parameters: beam codebook subset restriction indicating the subset of beams in the beam codebook subset used for beam information indication and/or predicted beam information report; report quantity indicating the report quantity for the predicted beams; beam matrix indicator (BMI) for each downlink reference signal in the first set indicating the beam from a beam codebook for the downlink reference signal; a first threshold indicating the beam prediction accuracy threshold; a second threshold indicating the predicted L1-RSRP/L1-SINRthreshold.
Example 7. The apparatus according to Example 1, wherein the UE receives the first control signaling indicating at least the BMI for each downlink reference signal in the first set.
Example 8. The apparatus according to Example 1, wherein the UE transmits the second set of predicted beam index(es) based on the order determined by the beam prediction accuracy for each predicted beam.
Example 9. The apparatus according to Example 1, wherein the UE transmits the second set of predicted beam index(es) based on the order determined by the predicted layer 1 reference signal receiving power (L1-RSRP) for each predicted beam.
Example 10. The apparatus according to Example 1, wherein the UE transmits the second set of predicted beam index(es) based on the order determined by the predicted layer 1 signal-to-interference plus noise (L1-SINR) for each predicted beam.
Example 11. The apparatus according to Example 1, wherein the UE transmits the beam prediction accuracy for at least one predicted beam in addition to the second set of predicted beam index(es).
Example 12. The apparatus according to Example 1, wherein the UE transmits the L1-RSRP for at least one predicted beam in addition to the second set of predicted beam index(es).
Example 13. The apparatus according to Example 1, wherein the LIE transmits the L1-SINR for at least one predicted beam in addition to the second set of predicted beam index(es).
Example 14. The apparatus according to Example 1, wherein the UE transmits a report indicating preferred beam codebook and/or preferred measured beams.
Example 15. The apparatus according to Example 14, wherein the UE transmits the report by RRC signaling.
Example 16. The apparatus according to Example 14, wherein the UE transmits the report by MAC control element (CE).
Example 17. The apparatus according to Example 14, wherein the UE transmits the report by Uplink Control Information (UCI) report.
Example 18. The apparatus according to Example 1, wherein the UE receives the first control signaling by RRC signaling.
Example 19. The apparatus according to Example 7, wherein the UE receives the second control signaling by MAC CE.
Example 20. The apparatus according to Example 7, wherein the UE receives the second control signaling by DCI.
Example 21 is an apparatus for wireless communication for implementing a method as in any of examples 1-20.
Example 22 is an apparatus for wireless communication including means for implementing a method as in any of examples 1-20.
Example 23 is a non-transitory computer-readable medium storing computer executable code, the code when executed by a processor causes the processor to implement a method as in any of examples 1-20.

### Network Entity Aspect

Example 1. An apparatus, comprising a processer configured to cause a Base Station (BS) to:
   transmit a first control signaling indicating at least one beam codebook for beam prediction and a first set of downlink reference signals for beam prediction;
   transmit the first set of downlink reference signals for beam prediction:
   receive at least a second set of predicted beam index(es) report based on one of the configured beam codebooks and the transmitted first set of downlink reference signals.
Example 2. The apparatus according to Example 1, wherein the BS receives UE capability on supported beam codebook assumptions.
Example 3. The apparatus according to Example 2, wherein the BS receives the UE capability for a beam codebook assumption with at least one of the UE capabilities including horizontal angle span for the beam grid; number of horizontal beams; vertical angle span for the beam grid; number of vertical beams; vertical and horizontal angle for each beam; number of horizontal antenna elements/ports; number of vertical antenna elements/ports; antenna spacing in vertical domain; antenna spacing in horizontal domain.
Example 4. The apparatus according to Example 2, wherein the BS receives the UE capability for a beam codebook assumption with at least one of the UE capabilities including oversampling factor in horizontal domain: oversampling factor in vertical domain; number of horizontal antenna elements/ports; number of vertical antenna elements/ports.
Example 5. The apparatus according to Example 2, wherein the BS further receives one or more than one UE capabilities including: the minimal number of downlink reference signals for beam prediction, the maximum number of downlink reference signals in a slot for beam prediction, the minimal number of predicted beams to identify the best beam, the maximum number of predicted beams to identify the best beam, and the preferred beams for measurement.
Example 6. The apparatus according to Example 1, wherein the BS transmits the first control signaling indicating at least one of the parameters: beam codebook subset restriction indicating the subset of beams in the beam codebook subset used for beam information indication and/or predicted beam information report; report quantity indicating the report quantity for the predicted beams; beam matrix indicator (BMI) for each downlink reference signal in the first set indicating the beam from a beam codebook for the downlink reference signal; a first threshold indicating the beam prediction accuracy threshold; a second threshold indicating the predicted L1-RSRP/L1-SINR threshold
Example 7. The apparatus according to Example 1, wherein the BS transmits the first control signaling indicating at least the BMI for each downlink reference signal in the first set.
Example 8. The apparatus according to Example 1, wherein the BS receives the beam prediction accuracy for at least one predicted beam in addition to the second set of predicted beam index(es).
Example 9. The apparatus according to Example 1, wherein the BS receives the L1-RSRP for at least one predicted beam in addition to the second set of predicted beam index(es).
Example 10. The apparatus according to Example 1, wherein the BS receives the L1-SINR for at least one predicted beam in addition to the second set of predicted beam index(es).

Example 11. The apparatus according to Example 1, wherein the BS receives a report indicating preferred beam codebook and/or preferred measured beams.
Example 12. The apparatus according to Example 11, wherein the BS receives the report by RRC signaling.
Example 13. The apparatus according to Example 11, wherein the BS receives the report by MAC control element (CE).
Example 14. The apparatus according to Example 11, wherein the BS receives the report by Uplink Control Information (UCI) report.
Example 15. The apparatus according to Example 1, wherein the BS transmits the first control signaling by RRC signaling.
Example 16. The apparatus according to Example 7, wherein the BS transmits the second control signaling by MAC CE.
Example 17. The apparatus according to Example 7, wherein the BS transmits the second control signaling by DCI.
Example 18 is an apparatus for wireless communication for implementing a method as in any of examples 1-17.
Example 19 is an apparatus for wireless communication including means for implementing a method as in any of examples 1-17.
Example 20 is a non-transitory computer-readable medium storing computer executable code, the code when executed by a processor causes the processor to implement a method as in any of examples 1-17.

1-38. (canceled)

39. A method for wireless communications performed by a user equipment (UE), the method comprising:
receiving, from a network entity, a first control signaling that includes at least one beam codebook representing beam-related assumptions and a first set of parameters for a predicted beam report;
measuring quality of downlink reference signals received from the network entity on test beams among beams transmittable from the network entity to the UE;
generating a beam prediction using the at least one beam codebook, to predict quality of predicted beams among the beams transmittable by the network entity, based on the measured quality of the downlink reference signals; and
transmitting, to the network entity, the predicted beam report based on the beam prediction and generated according to the first set of parameters.

40. The method of claim 39, wherein the at least one beam codebook includes codebook parameters for identifying the beams transmittable from the network entity to the UE using phase offsets, the codebook parameters including at least one of
a horizontal angle of span of a beam grid transmittable by the network entity via an antenna device;
a vertical angle of span of the beam grid;
a number of horizontal beams of the beam grid of the antenna;
a number of vertical beams of the beam grid;
a vertical and horizontal angle for each beam;
a number of horizontal antenna ports;
a number of vertical antenna ports;
an antenna spacing in a vertical space domain; or
an antenna spacing in a horizontal space domain.

41. The method of claim 39, wherein the at least one beam codebook includes codebook parameters for identifying the beams transmittable from the network entity to the UE using digital Fourier transform vectors, the codebook parameters including at least one of:
an oversampling factor in a horizontal space domain;
an oversampling factor in a vertical space domain;
a number of horizontal antenna ports; or
a number of vertical antenna ports.

42. The method of claim 39, further comprising:
transmitting, to the network entity, a message indicating a capability of the UE to use the at least one beam codebook for generating the beam prediction.

43. The method of claim 42, wherein the message indicating the capability of the UE to use the at least one beam codebook for the beam prediction performed by the UE includes one or more of:
a minimum number of downlink reference signals needed for the beam prediction;
a maximum number of downlink reference signals usable for the beam prediction;
a maximum number of downlink reference signals in a slot for the beam prediction;
a minimum number of predicted beams needed to identify the best beam;
a maximum number of predicted beams usable to identify the best beam; or
one or more preferred beams for the measuring.

44. The method of claim 39, wherein the first control signaling further comprises at least one of:
a beam codebook subset restriction indicating a subset of the predicted beams to be used for a beam information indication, the predicted beam report, or both;
a report quantity indicating a number of the predicted beams to be included in the predicted beam report;
a beam matrix indicator (BMI) for each beam in the test beams;
a first threshold for limiting a beam prediction accuracy of any one of the predicted beams included in the predicted beam report; or
a second threshold for limiting a predicted reference signal received power (RSRP) or a predicted signal-to-interference plus noise ratio (SINR) of any one of the predicted beams included in the predicted beam report.

45. The method of claim 39, further comprising:
generating the beam prediction using a machine learning, ML, model, wherein the predicted beam report indicates at least one of the predicted beams in the beam prediction having highest predicted RSRP, SINR, or both, and the predicted beam report includes quality information of the one or more predicted beams identified in either a spatial domain or in a time domain.

46. The method of claim 39, wherein the beam prediction report comprises at least one of:
a set of predicted beam indexes ordered based on beam prediction accuracies of one or more reported predicted beams;
a set of predicted beam indexes ordered based on a predicted reference signal received power, RSRP, of one or more reported predicted beams or ordered based on a predicted signal-to-interference plus noise ratio, SINR, of the one or more reported predicted beams;
a beam codebook index corresponding to one of the at least one beam codebook;
beam quality information corresponding to the beam prediction obtained using the one of the at least one beam codebook;
a beam prediction accuracy of at least one beam in the beam prediction;
an RSRP of at least one beam in the beam prediction; or
an SINR of at least one beam in the beam prediction.

47. The method of claim 39, wherein the at least one beam codebook indicates two or more beam codebooks, the method further comprising:
selecting a preferred beam codebook among the two or more beam codebooks, the beam prediction generated using the preferred beam codebook yielding a best predicted beam quality and/or accuracy, wherein the beam prediction report further comprises:
an indication of the preferred beam codebook; and
a set of preferred beams among beams in the beam prediction generated using the preferred beam codebook.

48. The method of claim 39, further comprising:
receiving, from the network entity, a second control signaling indicating that the network entity initiates sending the downlink reference signals, the second control signaling including a second set of parameters for the beam prediction report, wherein the beam prediction report is further based on the second set of parameters.

49. The method of claim 39, wherein the first control signaling further comprises:
beam information of the downlink reference signals corresponding to the test beams, wherein the measuring of the quality of the downlink reference signals received from the network entity is based on the beam information in the first control signaling.

50. A method for wireless communications by a network entity, the method comprising:
transmitting, to a user equipment (UE), a first control signaling that includes at least one beam codebook representing beam-related assumptions and a first set of parameters for a predicted beam report;
transmitting downlink reference signals to the UE for measurements and beam prediction; and
receiving, from the UE, a predicted beam report based on a beam prediction generated by the UE using the at least one beam codebook and measurements of the downlink reference signals to predict quality of predicted beams among beams transmittable by the network entity.

51. The method of claim 50, wherein the at least one beam codebook includes codebook parameters for identifying the beams transmittable from the network entity to the UE using phase offsets, the codebook parameters including one or more of:
a horizontal angle of span of a beam grid transmittable by the network entity via an antenna device;
a vertical angle of span of the beam grid;
a number of horizontal beams of the beam grid of the antenna;
a number of vertical beams of the beam grid;
a vertical and horizontal angle for each beam;
a number of horizontal antenna ports;
a number of vertical antenna ports;
an antenna spacing in a vertical space domain; or
an antenna spacing in a horizontal space domain.

52. The method of claim 50, wherein the at least one beam codebook includes codebook parameters for identifying the beams transmittable from the network entity to the UE using digital Fourier transform vectors, the codebook parameters including one or more of:
an oversampling factor in a horizontal space domain;
an oversampling factor in a vertical space domain;
a number of horizontal antenna ports; and
a number of vertical antenna ports.

53. The method of claim 50, further comprising:
receiving, from the UE, a message indicating a capability of the UE to use the at least one beam codebook for generating the beam prediction.

54. The method of claim 53, wherein the message indicating the capability of the UE to use the at least one beam codebook for the beam prediction performed by the UE includes at least one of:
a minimum number of downlink reference signals needed for the beam prediction;
a maximum number of downlink reference signals usable for the beam prediction;
a maximum number of downlink reference signals in a slot for the beam prediction;
a minimum number of predicted beams needed to identify a best beam;
a maximum number of predicted beams usable to identify the best beam; or
one or more preferred beams for the measuring.

55. The method of claim 50, wherein the first control signaling further comprises one or more of:
a beam codebook subset restriction indicating a subset of the predicted beams to be used for a beam information indication, the predicted beam report, or both;
a report quantity indicating a number of the predicted beams to be included in the predicted beam report;
a beam matrix indicator (BMI) for a test beam;
a first threshold for limiting a beam prediction accuracy of any one of the predicted beams included in the predicted beam report; or
a second threshold for limiting a predicted reference signal received power (RSRP) or a predicted signal-to-interference plus noise ratio (SINR) of any one of the predicted beams included in the predicted beam report.

56. The method of claim 50, wherein the at least one beam codebook indicates two or more beam codebooks, the method further comprising:
receiving, from the UE, a preferred beam codebook among two or more beam codebooks, wherein the beam prediction report further comprises:
an indication of the preferred beam codebook; and
a set of preferred beams among beams in the beam prediction generated using the preferred beam codebook.

57. The method of claim 50, further comprising:
transmitting, to the UE, a second control signaling indicating that the network entity initiates sending the downlink reference signals, the second control signaling including a second set of parameters for the beam prediction report, wherein the beam prediction report is further based on the second set of parameters.

58. A user equipment (UE) for wireless communication comprising:
a transceiver; and
a processor coupled to the transceiver, the processor configured to:
receive, from a network entity, a first control signaling that includes at least one beam codebook representing beam-related assumptions and a first set of parameters for a predicted beam report;
measure quality of downlink reference signals received from the network entity on test beams among beams transmittable from the network entity to the UE;
generate a beam prediction using the at least one beam codebook, to predict quality of predicted beams among the beams transmittable by the network entity, based on the measured quality of the downlink reference signals; and
transmit, to the network entity, the predicted beam report based on the beam prediction and generated according to the first set of parameters.
